(19) United States
(12) Patent Application Publication
(10) Pub. No.: US 2013/0336405 A1
(43) Pub. Date: Dec. 19, 2013

(54) DISPARITY VECTOR SELECTION IN VIDEO CODING

(71) Applicant: QualComm Incorporated, San Diego, CA (US)

(72) Inventors: Ying CHEN, San Diego, CA (US); Li Zhang, San Diego, CA (US)

(21) Appl. No.: 13/917,243

(22) Filed: Jun. 13, 2013

Related U.S. Application Data
(60) Provisional application No. 61/660,632, filed on Jun. 15, 2012.
(60) Provisional application No. 61/667,354, filed on Jul. 2, 2012.

(51) Int. Cl. H04N 7/34

(52) U.S. Cl. CPC H04N 19/00763
USPC 375/240.16

(57) ABSTRACT

A video coder determines a first disparity vector using a first disparity vector derivation process. In addition, the video coder determines a second disparity vector using a second disparity vector derivation process. The first disparity vector derivation process is different than the second disparity vector derivation process. The video coder uses the first disparity vector to determine a motion vector prediction (MVP) candidate in a set of MVP candidates for a current prediction unit (PU). The video coder uses the second disparity vector to determine residual data.

This application claims the benefit of U.S. Provisional Patent Application No. 61/660,632, filed Jun. 15, 2012, and U.S. Provisional Patent Application No. 61/667,354, filed Jul. 2, 2012, the entire content of each of which are incorporated herein by reference.

### TECHNICAL FIELD

This disclosure relates to video coding (i.e., encoding and/or decoding of video data).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

A multi-view coding bitstream may be generated by encoding views, e.g., from multiple perspectives. Some three-dimensional (3D) video standards that have been developed, or are under development, make use of multiview coding aspects. For example, different views may transmit left and right eye views to support 3D video. Alternatively, some 3D video coding processes may apply so-called multiview plus depth coding. In multiview plus depth coding, a 3D video bitstream may contain not only texture view components, but also depth view components. For example, each view may comprise one texture view component and one depth view component.

### SUMMARY

In general, this disclosure describes disparity vector derivation for 3D video coding. In particular, a video coder uses different disparity vector derivation processes depending on whether the disparity vector is to be used for motion vector prediction or residual prediction. Thus, the video coder may determine a first disparity vector using a first disparity vector derivation process and may determine a second disparity vector using a second disparity vector derivation process. The video coder uses the first disparity vector to determine a motion vector prediction (MVP) candidate in a set of MVP candidates for a current prediction unit (PU). The video coder uses the second disparity vector to determine residual data.

In one example, this disclosure describes a method of decoding video data, the method comprising: determining a first disparity vector using a first disparity vector derivation process; determining a second disparity vector using a second disparity vector derivation process, wherein the first disparity vector derivation process is different than the second disparity vector derivation process; using the first disparity vector to determine a MVP candidate in a set of MVP candidates for a current PU; using the second disparity vector to determine residual data; and generating, based in part on the residual data and a selected MVP candidate in the set of MVP candidates, one or more blocks of a reconstructed picture.

In another example, this disclosure describes a method of encoding video data, the method comprising: determining a first disparity vector using a first disparity vector derivation process; determining a second disparity vector using a second disparity vector derivation process, wherein the first disparity vector derivation process is different than the second disparity vector derivation process; using the first disparity vector to determine a MVP candidate in a set of MVP candidates for a current PU; using the second disparity vector to determine residual data; and generating a bitstream that includes data indicating the residual data for the current PU and a selected MVP candidate in the set of MVP candidates.

In another example, this disclosure describes a video coder comprising one or more processors configured to: determine a first disparity vector using a first disparity vector derivation process; determine a second disparity vector using a second disparity vector derivation process, wherein the first disparity vector derivation process is different than the second disparity vector derivation process; use the first disparity vector to determine a MVP candidate in a set of MVP candidates for a current PU; and use the second disparity vector to determine residual data.

In another example, this disclosure describes a video coder comprising: means for determining a first disparity vector using a first disparity vector derivation process; means for determining a second disparity vector using a second disparity vector derivation process, wherein the first disparity vector derivation process is different than the second disparity vector derivation process; means for using the first disparity vector to determine a MVP candidate in a set of MVP candidates for a current PU; and means for using the second disparity vector to determine residual data.

In another example, this disclosure describes a computer-readable storage medium having instructions stored thereon that, when executed, configure a video coder to: determine a first disparity vector using a first disparity vector derivation process; determine a second disparity vector using a second disparity vector derivation process, wherein the first disparity vector derivation process is different than the second disparity vector derivation process; use the first disparity vector to determine a motion vector prediction (MVP) candidate in a set of MVP candidates for a current prediction unit (PU); and use the second disparity vector to determine residual data.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a conceptual diagram illustrating example spatial motion vector neighbors relative to a current prediction unit (PU).

FIG. 3 is a conceptual diagram illustrating an example 2:1 motion data compression of one line.

FIG. 4 is a conceptual diagram illustrating a Clean Random Access (CRA) picture and leading pictures.

FIG. 5 is a conceptual diagram illustrating an example multi-view coding decoding order.

FIG. 6 is a conceptual diagram illustrating an example prediction structure for multi-view coding.

FIG. 7 is a conceptual diagram illustrating an example spatial disparity motion vector.

FIG. 8 is a conceptual diagram illustrating an example temporal disparity motion vector.

FIG. 9 is a conceptual diagram illustrating an example implicit disparity vector.

FIG. 10 is a block diagram illustrating an example video encoder that may implement the techniques described in this disclosure.

FIG. 11 is a block diagram illustrating an example video decoder that may implement the techniques described in this disclosure.

FIG. 12 is a flowchart illustrating an example process for determining a disparity vector for use in advanced motion vector prediction (AMVP) mode, merge mode for motion vector prediction, and inter-view residual prediction.

FIG. 13 is a flowchart illustrating an example operation to determine a disparity vector for a current PU based on temporally-neighboring PUs.

FIG. 14 is a conceptual diagram illustrating example candidate regions of a candidate picture.

FIG. 15 is a flowchart illustrating an example disparity vector generation process.

FIG. 16 is a flowchart illustrating an example disparity vector generation process for the AMVP and inter-view residual prediction modes.

FIG. 17 is a conceptual diagram illustrating example locations that spatially neighbor a current PU.

FIG. 18 is a flowchart illustrating an example continuation of disparity vector generation process of FIGS. 15 and 16.

FIG. 19 is a flowchart illustrating an example continuation of the disparity vector generation process of FIGS. 15, 16 and 17.

FIG. 20 is a flowchart illustrating an example operation of a video encoder, in accordance with one or more techniques of this disclosure.

FIG. 21 is a flowchart illustrating an example operation of a video decoder, in accordance with one or more techniques of this disclosure.

### DETAILED DESCRIPTION

In High-Efficiency Video Coding (HEVC), a video encoder may signal the motion information of a current prediction unit (PU) using merge mode or advanced motion vector prediction (AMVP) mode. The motion information of the current PU may include one or more motion vectors (MVs), one or more reference indexes, and a prediction direction indicator.

When the video encoder signals the motion information of the current PU using merge mode, the video encoder generates a merge candidate list that includes a set of merge candidates. The merge candidate list may include merge candidates that specify the motion information of PUs that spatially or temporally neighbor the current PU. The PUs that spatially neighbor the current PU may be in the same picture as the current PU. The PUs that temporally neighbor the current PU may be at least partially co-located with the current PU, but are in pictures that occur at different time instances than the picture that contains the current PU. The video encoder may select one of the merge candidates from the merge candidate list and signal a position, within the merge candidate list, of the selected merge candidate. A video decoder may reconstruct the same merge candidate list and may determine, based on the signaled position, the selected merge candidate. The video decoder may then determine that the motion information of the current PU is the same as the motion information specified by the selected merge candidate.

When the video encoder signals the motion information of the current PU using AMVP mode, the video encoder generates an AMVP candidate list that includes a set of AMVP candidates. The AMVP candidate list may include AMVP candidates that specify the motion information of PUs that spatially or temporally neighbor the current PU. Furthermore, the video encoder may select an AMVP candidate from the AMVP candidate list. The video encoder may generate at least one motion vector difference (MVD) for the current PU. The MVD may indicate a difference between a motion vector of the current PU and a motion vector of the selected AMVP candidate. The video encoder may signal the MVD, a reference index, and a syntax element that indicates a position, within the AMVP candidate list, of the selected AMVP candidate. The video decoder may reconstruct the same AMVP candidate list and may determine, based on the signaled position, the selected AMVP candidate. The video decoder may then determine the motion vector of the current PU by adding the MVD to a motion vector specified by the selected AMVP candidate.

There is currently an effort to generate a 3-dimensional video coding (3DV) extension to HEVC, referred to as 3D-HEVC. 3D-HEVC provides for multiple views of the same scene from different viewpoints. In 3D-HEVC, pictures of different views occurring at the same time instance are associated with the same “access unit.” 3D-HEVC supports inter-view prediction. Inter-view prediction is similar to the motion compensation used in standard HEVC and may use the same syntax elements. However, when a video coder performs inter-view prediction on a PU, the video coder may use, as a reference picture in a reference picture list, a picture that is in the same access unit as the PU, but in a different view. In contrast, conventional motion compensation only uses pictures in different access units as reference pictures.

As mentioned above, a video coder (e.g., a video encoder or a video decoder) may generate a candidate list (e.g., a merge candidate list or an AMVP candidate list) when the motion information of a current PU is signaled using merge mode or AMVP mode. In 3D-HEVC, the candidate list may include an inter-view prediction candidate. The video encoder may use this inter-view prediction candidate in the same way that the video coder uses the other candidates in the candidate list.

The inter-view prediction candidate specifies the motion information of a reference PU. The reference PU may be a PU of a reference picture. The reference picture may be in the same access unit as the current PU, but is in a different view than the current PU. To determine the reference PU, the video coder may determine a disparity vector for the current PU. The disparity vector for the current PU may indicate a horizontal spatial displacement between the current PU and a location within the reference picture. The reference PU may be the PU of the reference picture that covers the location indicated by the disparity vector.

Furthermore, a video coder may use a disparity vector to locate a residual block in a reference view. This residual block may be referred to herein as a residual reference block. When residual prediction is enabled for a block, a video decoder may reconstruct the current block by adding the residual reference block to a predictive block of the current block and a signaled residual block for the current block.

In some instances, the video coder may determine the disparity vector for the current PU based on spatial disparity vectors (SDVs), temporal disparity vectors (TDVs), or implicit disparity vectors (IDVs). A SDV is a disparity motion vector of a PU that spatially neighbors the current PU. A TDV is a disparity motion vector of a PU in the same view as the current PU, but in a different access unit than the current PU. If a spatially or temporally neighboring PU of the current PU is coded using inter-view motion prediction, the disparity vector of the spatially or temporally neighboring PU is an IDV. A disparity motion vector is a motion vector pointing to a location within an inter-view reference picture. An inter-view reference picture is a picture that is in the same access unit as the current PU, but in a different view.

Furthermore, to determine the disparity vector for the current PU, the video coder may generate a disparity vector candidate list that includes a set of disparity vector candidates. Each of the disparity vector candidates specifies the disparity vector of one of the SDVs, TDVs, and IDVs identified above. The video coder may then select one of the disparity vector candidates from the disparity vector candidate list. The video coder may use the horizontal component of the selected disparity motion vector as the disparity vector for the current PU. Determining the disparity vector of the current PU in this way may be efficient because neither the disparity vector for the current PU nor a depth map for a current view component needs to be explicitly signaled in a bitstream.

In other examples, the video coder does not generate a disparity vector candidate list, per se. Rather, the video coder processes spatially- and temporally-neighboring PUs according to a specific, pre-defined order. When the video coder determines that a spatially- or temporally-neighboring PU has a SDV, TDV, or IDV, the video coder may use the horizontal component of the determined disparity motion vector (i.e., a determined SDV, TDV, or IDV) as the disparity vector for the current PU.

Because the disparity vector for the current PU is derived from disparity motion vectors (i.e., SDVs, TDVs, and IDVs), the disparity vector determined for the current PU may not be as accurate as if the disparity vector were determined from a depth map. Furthermore, the video coder typically selects the first available disparity vector from the disparity vector candidate list. However, other disparity vectors from other neighboring PUs may be more accurate than the first available disparity vector. Inaccuracies in the disparity vector may decrease coding efficiency, and thereby increase the size of a resulting bitstream.

The techniques of this disclosure may resolve one or more of these problems. For example, a video coder may determine a first disparity vector using a first disparity vector derivation process. Furthermore, the video coder may determine a second disparity vector using a second disparity vector derivation process, wherein the first disparity vector derivation process is different than the second disparity vector derivation process. The video coder may use the first disparity vector to determine a motion vector prediction (MVP) candidate in a set of MVP candidates for a current prediction unit (PU). In addition, the video coder may use the second disparity vector to determine residual data. By using different disparity vectors for inter-view motion vector prediction and inter-view residual prediction, the video coder may obtain disparity vectors that enable the video coder to predict motion vectors and residual data more accurately.

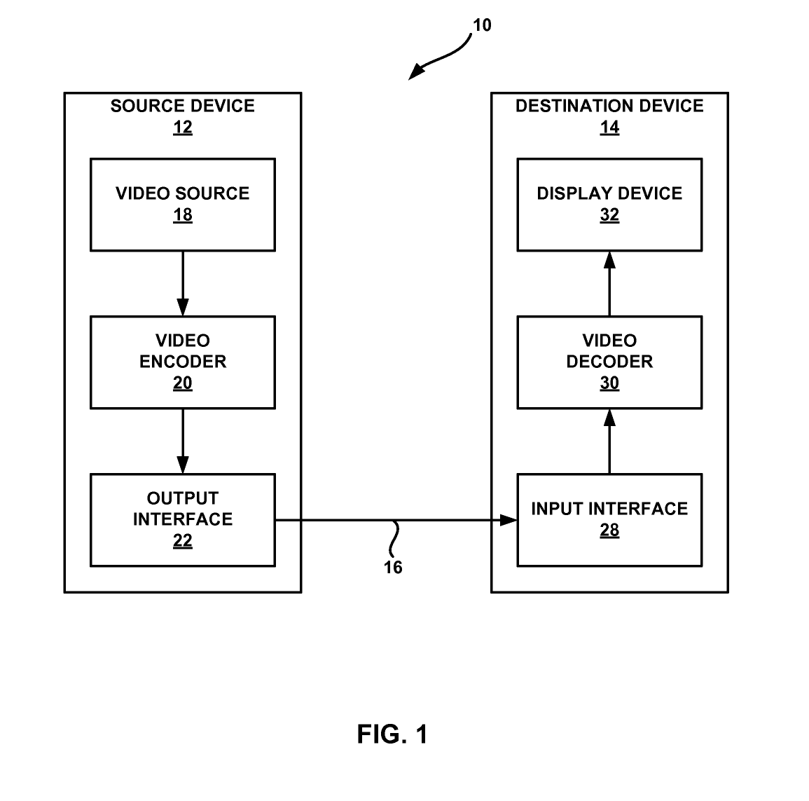

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

FIG. 1 is merely an example and the techniques of this disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information to another device, such as video decoder 30. The term “signaling” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium, such as, e.g., a storage medium remotely accessible via a file server or streaming server or a locally accessible storage device, in an encoded bitstream at the time of encoding, which then may be retrieved by a decoding device at any time after being stored to this medium.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) extension, Multiview Video Coding (MVC) extension, and MVC-based 3DV extension. In some instances, any legal bitstream conforming to MVC-based 3DV always contain a sub-bitstream that is compliant to a MVC profile, e.g., stereo high profile. Furthermore, there is an ongoing effort to generate a three-dimensional video (3DV) coding extension to H.264/AVC, namely AVC-based 3DV. In other examples, video encoder 20 and video decoder 30 may operate according to ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264, ISO/IEC Visual.

In the example of FIG. 1, video encoder 20 and video decoder 30 may operate according to the High Efficiency Video Coding (HEVC) standard presently under development by the Joint Collaboration Team on Video Coding (JCT-VC) of ITU-T Video Coding Experts Group (VCEG) and ISO/IEC Motion Picture Experts Group (MPEG). A draft of the upcoming HEVC standard, referred to as “HEVC Working Draft 6” is described in Bross et al., “High Efficiency Video Coding (HEVC) text specification draft 6,” Joint Collaborative Team on Video Coding (JCT-VC) of ITU-T SG16 WP3 and ISO/IEC JTC1/SC29/WG11, 7^{th} Meeting, Geneva, Switzerland, November 2011, which as of Jun. 13, 2013, is available from http://phenix.it-sudparis.eu/jct/doc_end user/documents/8_San%20Jose/wg11/JCTVC-H1003-v1.zip. Another draft of the upcoming HEVC standard, referred to as “HEVC Working Draft 9” is described in Bross et al., “High Efficiency Video Coding (HEVC) text specification draft 9,” Joint Collaborative Team on Video Coding (JCT-VC) of ITU-T SG16 WP3 and ISO/IEC JTC1/SC29/WG11, 11^{th} Meeting, Shanghai, China, October 2012, which as of Jun. 13, 2013, is available from http://phenix.int-evry.fr/jct/doc_end_user/documents/11_Shanghai/wg11/JCTVC-K1003-v13.zip.

Furthermore, there are ongoing efforts to produce scalable video coding, multi-view coding, and 3DV extensions for HEVC. The SVC extension of HEVC may be referred to as SHEVC. The 3DV extension of HEVC may be referred to as HEVC-based 3DV or 3D-HEVC. 3D-HEVC is based, at least in part, on solutions proposed in Schwarz et al, “Description of 3D Video Coding Technology Proposal by Fraunhofer HHI (HEVC compatible configuration A), ISO/IEC JTC1/SC29/WG11, Doc. MPEG11/M22570, Geneva, Switzerland, November/December 2011, hereinafter “m22570” and Schwarz et al, “Description of 3D Video Coding Technology Proposal by Fraunhofer HHI (HEVC compatible configuration B), ISO/IEC JTC1/SC29/WG11, Doc. MPEG11/M22571, Geneva, Switzerland, November/December 2011, hereinafter “m22571.” A reference software description for 3D-HEVC is available at Schwarz et al, “Test Model under Consideration for HEVC based 3D video coding,” ISO/IEC JTC1/SC29/WG11MPEG2011/N12559, San Jose, USA, February 2012. Reference software, namely HTM version 3.0 is available, as of Jun. 13, 2013, from https://hevc.hhi.fraunhofer.de/svn/svn_{—}3DVCSoftware/tags/HTM-3.0/.

In HEVC and other video coding standards, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other video coding standards, such as H.264/AVC. However, a CTU is not necessarily limited to a particular size and may include one or more coding units (CUs). A slice may include an integer number of CTUs ordered consecutively in raster scan.

This disclosure may use the term “video unit” or “video block” to refer to one or more blocks of samples and syntax structures used to code samples of the one or more blocks of samples. Example types of video units may include CTUs, CUs, PUs, transform units (TUs), macroblocks, macroblock partitions, and so on.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples of a picture, two corresponding prediction blocks of chroma samples of the picture, and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Inter prediction may be uni-directional inter prediction (i.e., uni-prediction) or bi-directional inter prediction (i.e., bi-prediction). To perform uni-prediction or bi-prediction, video encoder 20 may generate a first reference picture list (RefPicList0) and a second reference picture list (RefPicList1) for a current slice. Each of the reference picture lists may include one or more reference pictures. When using uni-prediction, video encoder 20 may search the reference pictures in either or both RefPicList0 and RefPicList1 to determine a reference location within a reference picture. Furthermore, when using uni-prediction, video encoder 20 may generate, based at least in part on samples corresponding to the reference location, the predictive sample blocks for the PU. Moreover, when using uni-prediction, video encoder 20 may generate a single motion vector that indicates a spatial displacement between a prediction block of the PU and the reference location. To indicate the spatial displacement between a prediction block of the PU and the reference location, a motion vector may include a horizontal component specifying a horizontal displacement between the prediction block of the PU and the reference location and may include a vertical component specifying a vertical displacement between the prediction block of the PU and the reference location.

When using bi-prediction to encode a PU, video encoder 20 may determine a first reference location in a reference picture in RefPicList0 and a second reference location in a reference picture in RefPicList1. Video encoder 20 may then generate, based at least in part on samples corresponding to the first and second reference locations, the predictive blocks for the PU. Moreover, when using bi-prediction to encode the PU, video encoder 20 may generate a first motion vector indicating a spatial displacement between a sample block of the PU and the first reference location and a second motion vector indicating a spatial displacement between the prediction block of the PU and the second reference location.

After video encoder 20 generates predictive luma, Cb and Cr blocks for one or more PUs of a CU, video encoder 20 may generate a luma residual block for the CU. Each sample in the CU's luma residual block may indicate a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and Cr residual blocks of a CU into one or more luma, Cb and Cr transform blocks. A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. Furthermore, video encoder 20 may inverse quantize transform coefficients and apply an inverse transform to the transform coefficients in order to reconstruct transform blocks of TUs of CUs of a picture. The video encoder 20 may use the reconstructed transform blocks of TUs of a CU and the predictive blocks of PUs of the CU to reconstruct coding blocks of the CU. By reconstructing the coding blocks of each CU of a picture, video encoder 20 may reconstruct the picture. Video encoder 20 may store reconstructed pictures in a decoded picture buffer (DPB). Video encoder 20 may use reconstructed pictures in the DPB for inter prediction and intra prediction.

After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for Supplemental Enhancement Information (SEI), and so on. A PPS is a syntax structure that may contain syntax elements that apply to zero or more entire coded pictures. NAL units that encapsulate RBSPs for video coding data (as opposed to RBSPs for parameter sets and SEI messages) may be referred to as video coding layer (VCL) NAL units. A NAL unit that encapsulates a coded slice may be referred to herein as a coded slice NAL unit. An RBSP for a coded slice may include a slice header and slice data.

The headers of NAL units include nuh_reserved_zero_{—}6 bits syntax elements. The nuh_reserved_zero_{—}6 bits syntax element of a NAL unit is equal to 0 if the NAL unit relates to a base layer in multi-view coding, 3DV coding, or scalable video coding. Data in a base layer of a bitstream may be decoded without reference to data in any other layer of the bitstream. If the NAL unit does not relate to a base layer in multi-view coding, 3DV, or scalable video coding, the nuh_reserved_zero_{—}6 bits syntax element may have other non-zero values. Specifically, if a NAL unit does not relate to a base layer in multi-view coding, 3DV, or scalable video coding, the nuh_reserved_zero_{—}6 bits syntax element of the NAL unit specifies a layer identifier.

Furthermore, some pictures within a layer may be decoded without reference to other pictures within the same layer. Thus, NAL units encapsulating data of certain pictures of a layer may be removed from the bitstream without affecting the decodability of other pictures in the layer. For example, pictures with even picture order count (POC) values may be decodable without reference to pictures with odd POC values. A POC is a variable associated with a coded picture and has a value that is increasing with increasing picture position in output order relative to a previous Instantaneous Decoding Refresh (IDR) picture in decoding order, if any. Removing NAL units encapsulating data of such pictures may reduce the frame rate of the bitstream. A subset of pictures within a layer that may be decoded without reference to other pictures within the layer may be referred to herein as a sub-layer.

NAL units may include nuh_temporal id_plus 1 syntax elements. The nuh_temporal_id_plus1 syntax element of a NAL unit may specify a temporal identifier (i.e., a temporal_id) of the NAL unit. If the temporal identifier of a first NAL unit is less than the temporal identifier of a second NAL unit, the data encapsulated by the first NAL unit may be decoded without reference to the data encapsulated by the second NAL unit.

Operation points of a bitstream are each associated with a set of layer identifiers (i.e., a set of nuh_reserved_zero_{—}6 bits values) and a temporal identifier. The set of layer identifiers may be denoted as OpLayerldSet and the temporal identifier may be denoted as TemporalID. If a NAL unit's layer identifier is in an operation point's set of layer identifiers and the NAL unit's temporal identifier is less than or equal to the operation point's temporal identifier, the NAL unit is associated with the operation point. An operation point representation is a bitstream subset (i.e., a sub-bitstream) that is associated with an operation point. The operation point representation of an operation point may include each NAL unit that is associated with the operation point. The operation point representation does not include VCL NAL units that are not associated with the operation point.

An external source may specify a set of target layer identifiers for an operation point. For example, an intermediate network device, such as a media-aware network element (MANE) or a content delivery network (CDN) device may specify the set of target layer identifiers. In this example, the intermediate network device may use the set of target layer identifiers to identify an operation point. The intermediate network device may then extract the operation point representation for the operation point and forward the operation point representation, instead of the original bitstream, to a client device. Extracting and forwarding the operation point representation to the client device may reduce the bit rate of the bitstream.

Video decoder 30 may receive a bitstream. In addition, video decoder 30 may parse the bitstream to decode syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use motion vectors of PUs to determine predictive blocks for the PUs of a current CU. Video decoder 30 may use motion vector or motion vectors of PUs to generate predictive blocks for the PUs.

In addition, video decoder 30 may inverse quantize coefficient blocks associated with TUs of the current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive sample blocks for PUs of the current CU to corresponding samples of the transform blocks of the TUs of the current CU. By reconstructing the coding blocks for each CU of a picture, video decoder 30 may reconstruct the picture. Video decoder 30 may store decoded pictures in a decoded picture buffer for output and/or for use in decoding other pictures.

When a video coder (e.g., video encoder 20 or video decoder 30) begins coding a current slice of a picture, the video coder may initialize a first reference picture list (i.e., List 0). Furthermore, if the current slice is a B slice, the video coder may initialize a second reference picture list (i.e., List 1). This disclosure may refer to List 0 as “RefPicList0” and may refer to List 1 as “RefPicList1.” After a video coder has initialized a reference picture list (e.g., List 0 or List 1), the video coder may modify the order of the reference pictures in the reference picture list. In other words, the video coder may perform a reference picture list modification (RPLM) process. The video coder may modify the order of the reference pictures in any order, including the case where one particular reference picture may appear in more than one position in the reference picture list. Furthermore, in some proposals for HEVC, a video coder may generate a combined reference picture list (i.e., List C). List C may also be referred to herein as “RefPicListC”). The video coder may construct List C from List 0 and List 1 after applying RPLM processes to List 0 and List 1. For instance, for a B slice, a combined list (RefPicListC) is constructed after the final reference picture lists (RefPicList0 and RefPicList1) have been constructed. Video decoder 30 may further modify List C if RPLM syntax elements are present for List C.

In some cases, video encoder 20 may signal the motion information of a PU using merge mode or advanced motion vector prediction (AMVP) mode. In other words, in HEVC, there are two modes for the prediction of motion parameters, one being the merge mode and the other being AMVP. The motion information of a PU may include motion vector(s) of the PU and reference index(s) of the PU. When video encoder 20 signals the motion information of a current PU using merge mode, video encoder 20 generates a merge candidate list (i.e., a motion vector predictor (MVP) candidate list). In other words, video encoder 20 may perform a motion vector predictor list construction process. The merge candidate list includes a set of merge candidates (i.e., MVP candidates). The merge candidate list may include merge candidates that indicate the motion information of PUs that spatially or temporally neighbor the current PU. That is, in the merge mode, a candidate list of motion parameters (e.g., reference indexes, motion vectors, etc.) is constructed where a candidate can be from spatial and temporal neighboring blocks.

Furthermore, in merge mode, video encoder 20 may select a merge candidate from the merge candidate list and may use the motion information indicated by the selected merge candidate as the motion information of the current PU. Video encoder 20 may signal the position in the merge candidate list of the selected merge candidate. For instance, video encoder 20 may signal the selected motion vector parameters by transmitting an index into the candidate list. Video decoder 30 may obtain, from the bitstream, the index into the candidate list (i.e., a candidate list index). In addition, video decoder 30 may generate the same merge candidate list and may determine, based on the indication of the position of the selected merge candidate, the selected merge candidate. Video decoder 30 may then use the motion information of the selected merge candidate to generate predictive blocks for the current PU. That is, video decoder 30 may determine, based at least in part on the candidate list index, a selected candidate in the candidate list, wherein the selected candidate specifies the motion vector for the current PU. In this way, at the decoder side, once the index is decoded, all motion parameters of the corresponding block where the index points are to be inherited by the current PU.

Skip mode is similar to merge mode. In skip mode, video encoder 20 and video decoder 30 generate and use a merge candidate list in the same way that video encoder 20 and video decoder 30 use the merge candidate list in merge mode. However, when video encoder 20 signals the motion information of a current PU using skip mode, video encoder 20 does not signal any residual data for the current PU. Accordingly, video decoder 30 may use, as a predictive block for the PU, a reference block indicated by the motion information of a selected candidate in the merge candidate list.

AMVP mode is similar to merge mode in that video encoder 20 generates a candidate list and selects a candidate from the list of candidates. However, when video encoder 20 signals the motion information of a current PU using AMVP mode, video encoder 20 also may signal a motion vector difference (MVD) for the current PU and a reference index in addition to signaling a position of the selected candidate in the candidate list. An MVD for the current PU may indicate a difference between a motion vector of the current PU and a motion vector of the selected candidate from the AMVP candidate list. In uni-prediction, video encoder 20 may signal one MVD and one reference index for the current PU. In bi-prediction, video encoder 20 may signal two MVDs and two reference indexes for the current PU. In this way, video encoder 20 may signal the selected motion vectors by transmitting an index into the candidate list and may signal the reference index values and MVDs. In other words, the data in the bitstream representing the motion vector for the current PU may include data representing a reference index, an index to a candidate list, and an MVD.

Furthermore, when the motion information of a current PU is signaled using AMVP mode, video encoder 30 may obtain, from the bitstream, a MVD for a current PU and a candidate list index. Video decoder 30 may generate the same AMVP candidate list and may determine, based on the indication of the position of the selected candidate in the AMVP candidate list, the selected candidate. Video decoder 30 may recover a motion vector of the current PU by adding a MVD to the motion vector indicated by the selected candidate. That is, video decoder 30 may determine, based at least in part on a motion vector indicated by the selected candidate and the MVD, the motion vector of the current PU. Video decoder 30 may then use the recovered motion vector or motion vectors of the current PU to generate predictive blocks for the current PU.

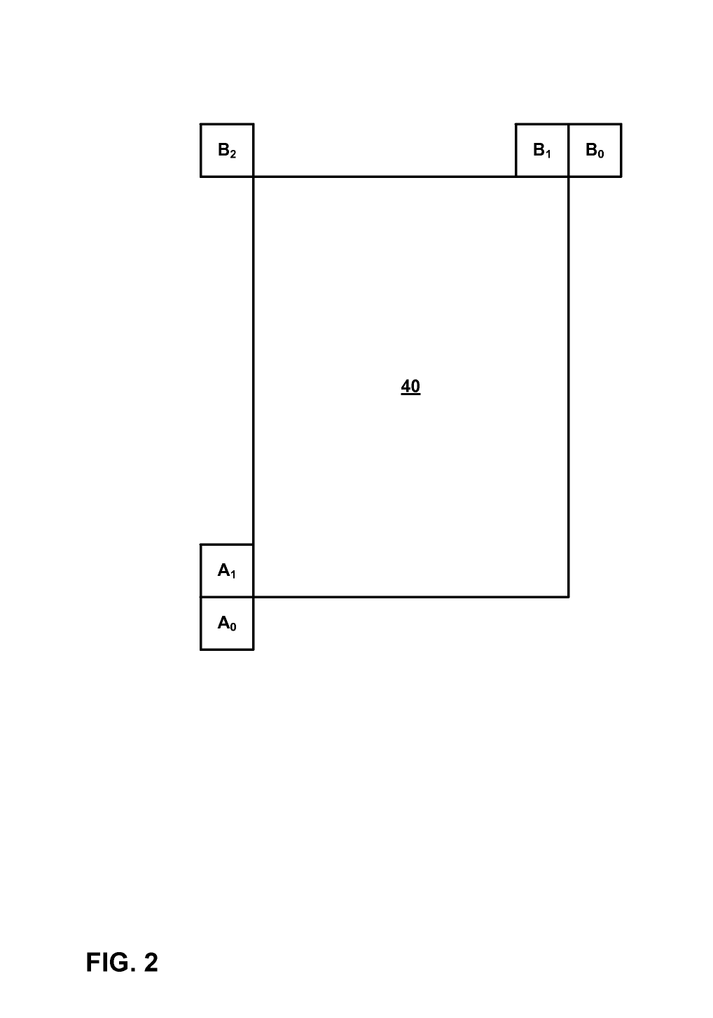

As indicated above, candidate lists for merge mode or AMVP may include candidates based on PUs that spatially neighbor a current PU. This disclosure may refer to such PUs as spatially-neighboring PUs or spatial motion vector neighbors. FIG. 2 is a conceptual diagram illustrating example spatial motion vector neighbors relative to a current PU 40. That is, an example relationship between PU 40 and spatially-neighboring PUs of PU 40 is depicted in FIG. 2. In the example of FIG. 2, the spatially-neighboring PUs may be PUs that cover the locations indicated as A₀, A₁, B₀, B₁, and B₂. A PU may cover a location when a prediction block of the PU includes the location.

With regard to the example of FIG. 2, a luma location (xP, yP) may specify the top-left luma sample of PU 40 relative to a top-left luma sample of the current picture. Furthermore, the variables nPSW and nPSH may respectively denote the width and height, in luma samples, of PU 40. The top-left luma sample of a PU N relative to the top-left sample of the current picture is (xN, yN), where N denotes a PU covering positions A₀, A₁, B₀, B₁, or B₂. For PUs covering positions A₀, A₁, B₀, B₁, or B₂, (xN, yN) may be defined as (xP−1, yP+nPSH), (xP−1, yP+nPSH−1), (xP+nPSW, yP−1), (xP+nPSW−1, yP−1) or (xP−1, yP−1), respectively.

A candidate in a merge candidate list or an AMVP candidate list that is based on the motion information of a PU that temporally neighbors a current PU (i.e., a PU that is in a different time instance than the current PU) may be referred to as a temporal motion vector predictor (TMVP). To determine a TMVP, a video coder may firstly identify a reference picture that includes a PU that is co-located with the current PU. In other words, the video coder may identify a co-located picture. If the current slice of the current picture is a B slice (i.e., a slice that is allowed to include bi-directionally inter predicted PUs), video encoder 20 may signal, in a slice header, a syntax element (e.g., collocated_from_{—}10_flag) that indicates whether the co-located picture is from RefPicList0 or RefPicList1. After video decoder 30 identifies the reference picture list that includes the co-located picture, video decoder 30 may use another syntax element (e.g., collocated_ref_idx), which may be signaled in a slice header, to identify a picture (i.e., the co-located picture) in the identified reference picture list.

A video coder may identify a co-located PU by checking the co-located picture. The TMVP may indicate either the motion information of a right-bottom PU of the CU containing the co-located PU, or the motion information of the right-bottom PU within the center PUs of the CU containing this PU. The right-bottom PU of the CU containing the co-located PU may be a PU that covers a location immediately below and right of a bottom-right sample of a prediction block of the PU. In other words, the TMVP may indicate the motion information of a PU that is in the reference picture and that covers a location that is co-located with a bottom right corner of the current PU, or the TMVP may indicate the motion information of a PU that is in the reference picture and that covers a location that is co-located with a center of the current PU.

When motion vectors identified by the above process are used to generate a motion candidate for merge mode or AMVP mode, the motion vectors may be scaled based on the temporal location (reflected by POC value). For instance, a video coder may increase the magnitude of a motion vector by greater amounts when a difference between the POC values of a current picture and a reference picture is greater than when a difference between the POC values of the current picture and the reference picture is less.

In HEVC Working Draft 6, the PPS includes an enable_temporal_mvp_flag syntax element. The enable_temporal_mvp_flag syntax element specifies whether temporal motion vector predictors can be used or not. When a particular picture with temporal_id equal to 0 refers to a PPS that has an enable_temporal_mvp_flag syntax element equal to 0 (i.e., when VCL NAL units associated with the particular picture specify temporal identifiers equal to 0 and are associated with a PPS having enable_temporal_mvp_flag equal to 0), a video coder may mark all reference pictures in a DPB as “unused for temporal motion vector prediction,” and the video coder may use no motion vectors from pictures before that particular picture in decoding order as a TMVP in decoding of the particular picture or a picture after the particular picture in decoding order.

HEVC may support motion vector compression for memory bandwidth reduction. The motion vector storage compression method in HEVC may be designed to reduce memory bandwidth spend on storing and loading temporal motion vectors for merge/skip mode and AMVP. In the context of HEVC, memory bandwidth may refer to the amount of data transferred to or from memory. In some examples, the compression method may be a 16× compression method. The 16× compression method may down-sample a motion vector field by a factor of 4 in both horizontal and vertical directions, resulting in a same motion vector for each 16×16 region. In other words, different 16×16 regions may have different motion vectors, but each PU within a 16×16 may have the same motion vectors.

A video coder (e.g., video encoder 20 or video decoder 30) may use a line buffer to store information associated with a row (i.e., a line) of CTUs in a picture. In some examples, the information associated with a row of CTUs may include the motion information of PUs associated with the CTUs in the row. HEVC may support motion data compression for line buffer reduction. That is, motion data may be compressed in order to reduce the amount of data stored in a line buffer. As discussed above, the motion data of a PU may include one or more inter prediction direction indicators, one or more reference picture indexes, and one or more motion vectors. If the motion information of a PU is signaled with reference to the motion information of a PU that occurs in a CTB row (i.e., an LCU row) above a CTU associated with the PU, only compressed motion data in a line buffer may be accessed.

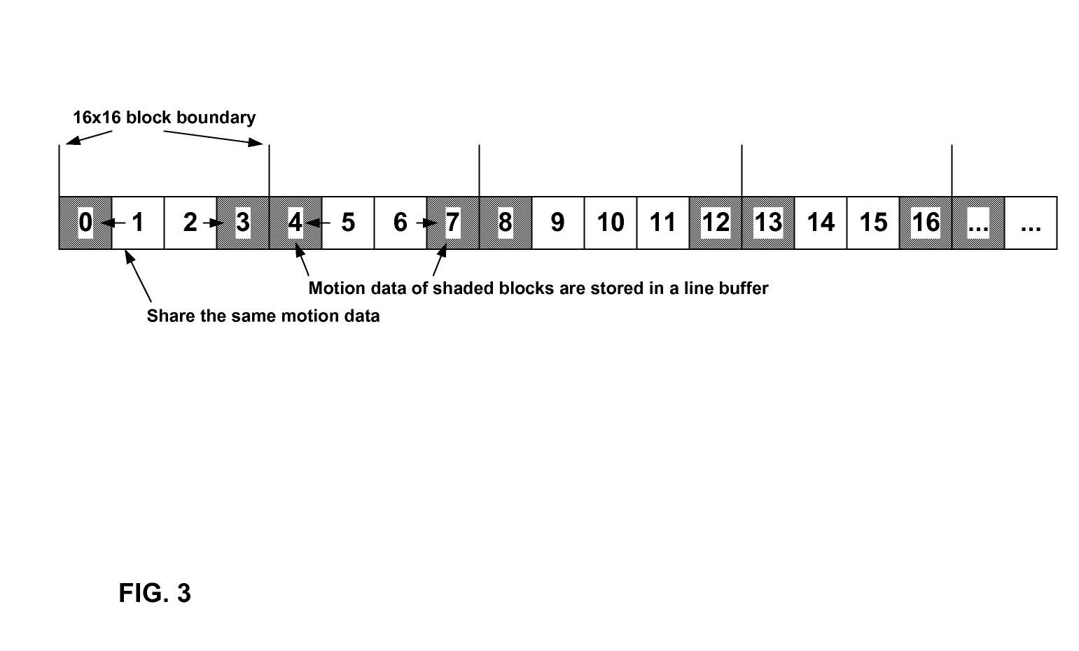

FIG. 3 is a conceptual diagram illustrating an example 2:1 motion data compression of one line. In the example of FIG. 3, each square corresponds to a 4×4 block. The line buffer does not store motion information for 4×4 blocks that correspond to the shaded squares. For every set of four 4×4 blocks, the motion data of the first and the last 4×4 block are stored in the line buffer. The motion data of the second block of a four block set is determined to be equal to the motion data of the first block of the four block set. In other words, the motion data of the first block represents the motion data of the first two blocks. The motion data of the third block of a four block set is determined to be equal to the motion data of the last block of the four block set. In other words, the motion data of the last block represents the motion data of the last two blocks. In this way, only half the memory is required.

Furthermore, in HEVC, a CTU may be divided into parallel motion estimation regions (PMERs). Only those neighboring PUs belonging to different MERs for a current PU are allowed to be included in the merge/skip motion vector predictor (MVP) list construction process. Thus, if a current PU and a spatially-neighboring PU are within the same PMER, a video coder does not include, in the merge/skip MVP candidate list, a MVP candidate that specifies the motion information of the spatially-neighboring PU. Hence, when the size of a PMER is larger than N×N, where 2N×2N is the smallest CU size, the PMER takes effect in a way that a spatially-neighboring block, if it is inside the same PMER as the current PU, is considered as unavailable. Video encoder 20 may signal the size of the PMER in a PPS (e.g., using a log2_parallel_merge_level_minus2 syntax element).

In HEVC, each NAL unit includes a syntax element (e.g., nal unit type) that indicates a NAL unit type of the NAL unit. Furthermore, in HEVC, video decoder 30 may identify, based on the NAL unit type of a NAL unit, the NAL unit as being associated with one of four picture types. In other words, there are four picture types that can be identified by the NAL unit type in HEVC. These four picture types are IDR pictures, Clean Random Access (CRA) pictures, Temporal Layer Access (TLA) pictures, and coded pictures that are not IDR, CRA, or TLA pictures.

The definition of an IDR picture in HEVC may be similar to the definition of an IDR picture in H.264/AVC. Similarly, the definition of a coded picture in HEVC may be similar to the definition of a coded picture in H.264/AVC. For instance, the IDR and the coded pictures may be picture types inherited from the H.264/AVC specification. An IDR picture may cause a decoding process to mark all reference pictures as “unused for reference.” Because reference pictures marked as “unused for reference” may be removed from a decoded picture buffer (DPB) that stores the reference pictures, an IDR picture may clean out the DPB. All coded pictures that follow an IDR picture in decoding order can be decoded without inter prediction from any picture that precedes the IDR picture in decoding order. The first picture of each coded video sequence in decoding order is an IDR picture. When a coded picture of an access unit is an IDR picture, the access unit may be referred to as an IDR access unit. A coded video sequence is a sequence of access units that consists, in decoding order, of an IDR access unit followed by zero or more non-IDR access units including all subsequent access units up to but not including any subsequent IDR access unit.

The CRA and TLA picture types are new in HEVC and are not available in the H.264/AVC specification. The CRA picture type facilitates decoding that begins from any random access point (RAP) in the middle of a video sequence. Inserting CRA pictures in a video sequence may be more efficient than inserting IDR pictures into the same video sequence. Random access is the act of starting a decoding process for a bitstream at a point other than the beginning of the bitstream. In HEVC, a bitstream starting from a CRA picture may be a conforming bitstream. That is, the portion of a bitstream that starts with a CRA picture may conform to the HEVC specification. A TLA picture can be used to indicate a valid temporal layer switching point.

In video applications such as broadcasting and streaming, users may switch between different channels and jump to specific parts of a video. Ideally, channel switching and jumping in this manner should be performed with a minimum amount of delay. Channel switching and jumping may be enabled by including random access pictures at regular intervals in video bitstreams. IDR pictures may be used in both H.264/AVC and HEVC as random access pictures. In other words, the IDR picture, specified in both H.264/AVC and HEVC can be used for random access. However, because an IDR picture starts a coded video sequence and may always clean the DPB, pictures following the IDR picture in decoding order cannot use pictures decoded prior, in decoding order, to the IDR picture for reference. Consequently, bitstreams relying on IDR pictures for random access may have significantly lower coding efficiency (e.g., 6% lower coding efficiency). To improve the coding efficiency, a CRA picture in HEVC may allow pictures that follow the CRA picture in decoding order, but precede the CRA picture in output order, to use pictures decoded before the CRA for reference.

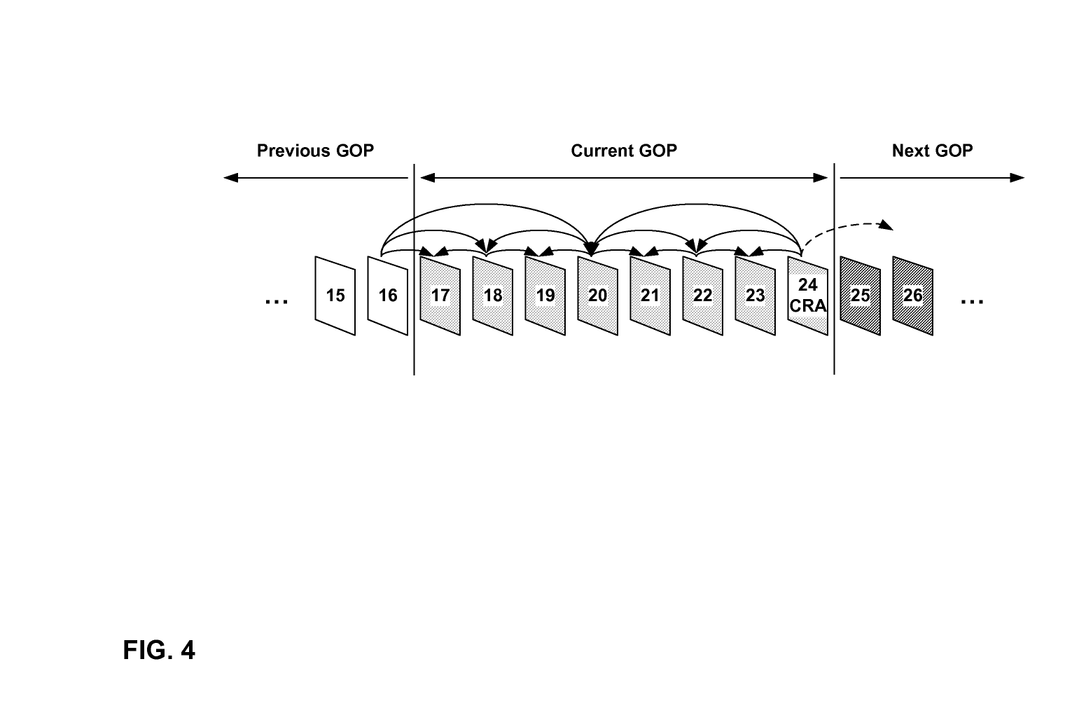

FIG. 4 is a conceptual diagram illustrating a CRA picture and leading pictures. That is, a typical prediction structure around a CRA picture is shown in the example of FIG. 4. In the example of FIG. 4, each parallelogram represents a picture. Numbers within each respective parallelogram indicate example POC values of the respective picture represented by the respective parallelogram. The CRA picture (i.e., the picture in the example of FIG. 4 with POC value 24) belongs to a Group of Pictures (GOP) that contains other pictures (i.e., pictures with POC values 17-23) following the CRA picture in decoding order, but preceding the CRA picture in output order. These pictures (i.e., the pictures follow the CRA picture in decoding order but precede the CRA picture in output order) may be referred to as “leading pictures” of the CRA picture. Video decoder 30 may correctly decode the leading pictures of a current CRA picture if the decoding starts from an IDR picture or a CRA picture that occurs in decoding order before the current CRA picture. However, video decoder 30 may not be able to correctly decode the leading pictures of a current CRA picture when random access from the current CRA picture occurs. Hence, video decoder 30 may discard the leading pictures of a current CRA picture during random access decoding from the current CRA picture.

Error propagation may occur when video decoder 30 uses an incorrectly decoded portion of a reference picture when decoding a current picture. To prevent error propagation from reference pictures that may not be available depending on where decoding starts, no picture in the GOP that follows a CRA picture may use as reference any picture that precedes the CRA picture in either decoding order or output order (including leading pictures of the CRA picture). Thus, in the example of FIG. 4, all pictures in the next GOP that follow the CRA picture both in decoding order and output order shall not use any picture that precedes the CRA picture either in decoding order or output order as reference.

Recovery point SEI messages may be used in H.264/AVC to provide random access in a manner similar to the CRA pictures in HEVC. In other words, H.264/AVC supports similar random access functionalities with a recovery point SEI message. An H.264/AVC decoder implementation may or may not support the recovery point SEI message functionality. In HEVC, a bitstream starting with a CRA picture is considered to be a conforming bitstream. When a bitstream starts with a CRA picture, the leading pictures of the CRA picture may refer to unavailable reference pictures and hence cannot be correctly decoded. However, HEVC specifies that the leading pictures of a starting CRA picture are not output, hence the name “clean random access.” For establishment of a bitstream conformance requirement, HEVC may specify a decoding process to generate unavailable reference pictures for decoding of the non-output leading pictures. However, conforming decoder implementations do not have to follow that decoding process, as long as the decoder implementations can generate identical output compared to when the decoding process is performed from the beginning of the bitstream. In HEVC, a conforming bitstream may include no IDR pictures at all and consequently may contain a subset of a coded video sequence or an incomplete coded video sequence.

In multi-view coding, there may be multiple views of the same scene from different viewpoints. The term “access unit” is used to refer to the set of pictures that correspond to the same time instance. Thus, video data may be conceptualized as a series of access units occurring over time. A “view component” may be a coded representation of a view in a single access unit. In this disclosure, a “view” may refer to a sequence of view components associated with the same view identifier.

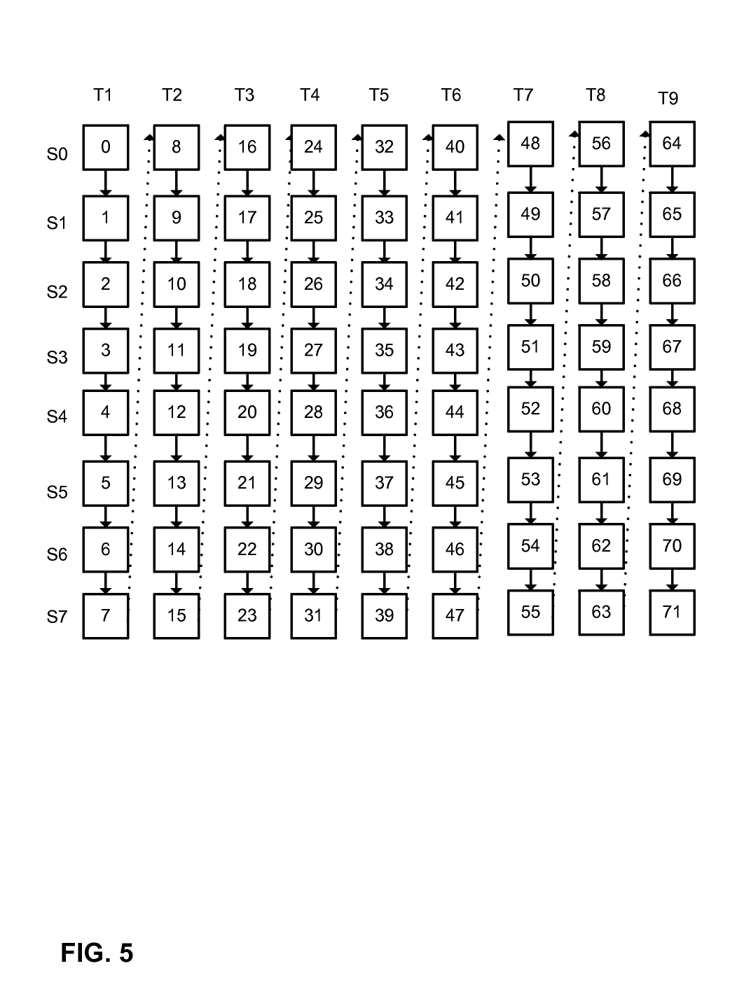

FIG. 5 is a conceptual diagram illustrating an example multi-view decoding order. The multi-view decoding order may be a bitstream order. In the example of FIG. 5, each square corresponds to a view component. Columns of squares correspond to access units. Each access unit may be defined to contain the coded pictures of all the views of a time instance. Rows of squares correspond to views. In the example of FIG. 5, the access units are labeled T0 . . . T9 and the views are labeled S0 . . . S7. Because each view component of an access unit is decoded before any view component of the next access unit, the decoding order of FIG. 5 may be referred to as time-first coding. The decoding order of access units may not be identical to the output or display order of the views.

Multi-view coding supports inter-view prediction. Inter-view prediction is similar to the inter prediction used in H.264/AVC, HEVC, or other video coding standards and may use the same syntax elements. However, when a video coder performs inter-view prediction on a current video unit (such as a macroblock), the video coder may use, as a reference picture, a picture that is in the same access unit as the current video unit, but in a different view. In contrast, conventional inter prediction only uses pictures in different access units as reference pictures.

In multi-view coding, a view may be referred to as a “base view” if a video decoder (e.g., video decoder 30) can decode pictures in the view without reference to pictures in any other view. When coding a picture in one of the non-base views, a video coder (such as video encoder 20 or video decoder 30) may add a picture into a reference picture list (e.g., RefPicList0 or RefPicList1) if the picture is in a different view but within a same time instance (i.e. access unit) as the picture that the video coder is currently coding. Like other inter prediction reference pictures, the video coder may insert an inter-view prediction reference picture at any position of a reference picture list.

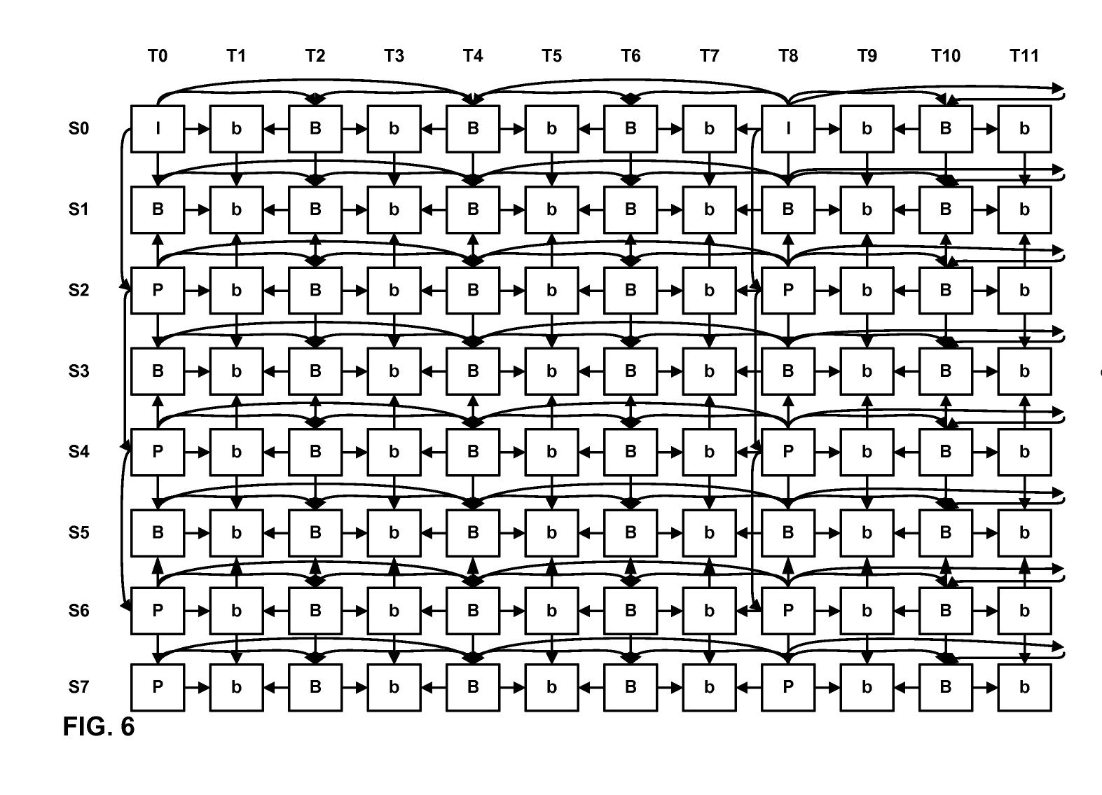

FIG. 6 is a conceptual diagram illustrating an example prediction structure for multi-view coding. The multi-view prediction structure of FIG. 6 includes temporal and inter-view prediction. In the example of FIG. 6, each square corresponds to a view component. Squares labeled “I” are intra predicted view components. Squares labeled “P” are uni-directionally inter predicted view components. Squares labeled “B” and “b” are bi-directionally inter predicted view components. Squares labeled “b” may use squares labeled “B” as reference pictures. An arrow that points from a first square to a second square indicates that the first square is available in inter prediction as a reference picture for the second square. As indicated by the vertical arrows in FIG. 6, view components in different views of the same access unit may be available as reference pictures. The use of one view component of an access unit as a reference picture for another view component of the same access unit may be referred to as inter-view prediction.

In the MVC extension of H.264/AVC, inter-view prediction is supported by disparity motion compensation, which uses the syntax of the H.264/AVC motion compensation, but allows a picture in a different view to be used as a reference picture. Coding of two views may also be supported by the MVC extension of H.264/AVC. One of the advantages of the MVC extension of H.264/AVC is that an MVC encoder may take more than two views as a 3D video input and an MVC decoder may decode such a multiview representation. Consequently, any renderer with a MVC decoder may expect 3D video contents with more than two views.

In the MVC extension of H.264/AVC, inter-view prediction is allowed among pictures in the same access unit (i.e., with the same time instance). When coding a picture in one of the non-base views, a picture may be added into a reference picture list, if the picture is in a different view but with a same time instance. An inter-view prediction reference picture can be put in any position of a reference picture list, just like any inter prediction reference picture.

Furthermore, in the context of multi-view video coding, there may be two types of motion vectors. One type of motion vector is a normal motion vector that points to temporal reference pictures. The other type of motion vector is a disparity motion vector that points to pictures in a different view and the corresponding inter prediction is disparity-compensated prediction (DCP).

3D-HEVC provides for multiple views of the same scene from different viewpoints. Part of the standardization efforts for 3D-HEVC includes the standardization of the multiview video codec based on HEVC. Similarly, in HEVC based 3DV, inter-view prediction based on the reconstructed view components from different views is enabled. Like MVC in H.264/AVC, 3D-HEVC supports inter-view motion prediction. In 3D-HEVC, IMP is similar to the motion compensation used in standard HEVC and may utilize the same or similar syntax elements. However, when a video coder performs inter-view motion prediction on a PU, the video coder may use, as a reference picture, a picture that is in the same access unit as the PU, but in a different view. In contrast, conventional motion compensation only uses pictures in different access units as reference pictures. Thus, in 3D-HEVC, the motion parameters of a block in a dependent view are predicted or inferred based on already coded motion parameters in other views of the same access unit.

A video coder may generate a MVP candidate list (e.g., a merge candidate list or an AMVP candidate list) when the motion information of a current PU is signaled using merge mode or AMVP mode. In 3D-HEVC, the candidate list may include an inter-view prediction candidate that may be used in the same manner as other candidates in the candidate list. The inter-view prediction candidate specifies the motion information of a PU (i.e. a reference PU) of a reference picture. The reference picture may be in the same access unit as the current PU, but is in a different view than the current PU. To determine the reference PU, the video coder may perform a disparity vector construction process to determine a disparity vector for the current PU. The disparity vector for the current PU may indicate a horizontal spatial displacement between the current PU and a location within the reference texture picture. The reference PU may be the PU of the reference texture picture that covers the location indicated by the disparity vector.

U.S. Provisional Patent Application 61/610,961, filed Mar. 14, 2012, describes a disparity vector construction method from spatial disparity vectors (SDVs), temporal disparity vectors (TDVs), or implicit disparity vectors (IDVs) for inter-view motion prediction. U.S. Patent Application 61/621,929, filed Apr. 9, 2012, describes another design following a similar concept. A disparity motion vector is a motion vector pointing to a location within an inter-view reference picture. An inter-view reference picture is a texture picture that is in the same access unit as a current PU, but in a different view.

A SDV is a disparity motion vector of a PU that spatially neighbors the current PU. In other words, a SDV is a motion vector that is specified by a spatially-neighboring PU and that indicates a location in an inter-view reference picture, where the spatially-neighboring PU spatially neighbors a current PU. A TDV is a disparity motion vector of a PU co-located with the current PU, in the same view as the current PU, and in a different access unit than the current PU. In other words, a TDV may be a disparity motion vector from co-located PU, co-located LCU in any reference picture or inter-view picture with the same access unit. Alternatively, if the motion vector of the co-located PU from the picture used for TMVP or the motion vector generated by TMVP is a disparity vector, it is also treated as a TDV. If a spatially-neighboring or a temporally-neighboring PU of the current PU is coded using inter-view motion prediction, the disparity vector of the spatially-neighboring or temporally-neighboring PU is an IDV.

Furthermore, to determine the disparity vector for the current PU, the video coder may generate a disparity vector candidate list that includes a set of disparity vector candidates. Each of the disparity vector candidates specifies one of the SDVs, TDVs, and IDVs identified above. In other words, a video coder may use disparity vectors from the above three kinds to construct a disparity vector candidate list (denoted disVecCan). The video coder may select, based on some criteria, one of the disparity vectors from disVecCan.

The video coder may use the selected disparity vector directly for inter-view motion prediction. As indicated above, a video encoder may generate MVP candidate lists for the current PU when signaling the motion information of the current PU using merge/skip mode or AMVP mode. The video coder may use the disparity vector specified by the selected disparity vector candidate to determine a reference PU in an inter-view reference picture. The video coder may then include the motion information of the reference PU as the inter-view prediction MV candidate in the MV candidate lists for merge mode or AMVP mode. In this way, the video coder does not need to calculate the disparity vector of the current PU based on a depth map, but rather may determine the disparity vector of the current PU based on the disparity vectors of spatially- or temporally-neighboring PUs. In some instances, determining the disparity vector of the current PU in this way may be efficient because neither the disparity vector for the current PU nor the depth map for the current view component need to be explicitly signaled in the bitstream.

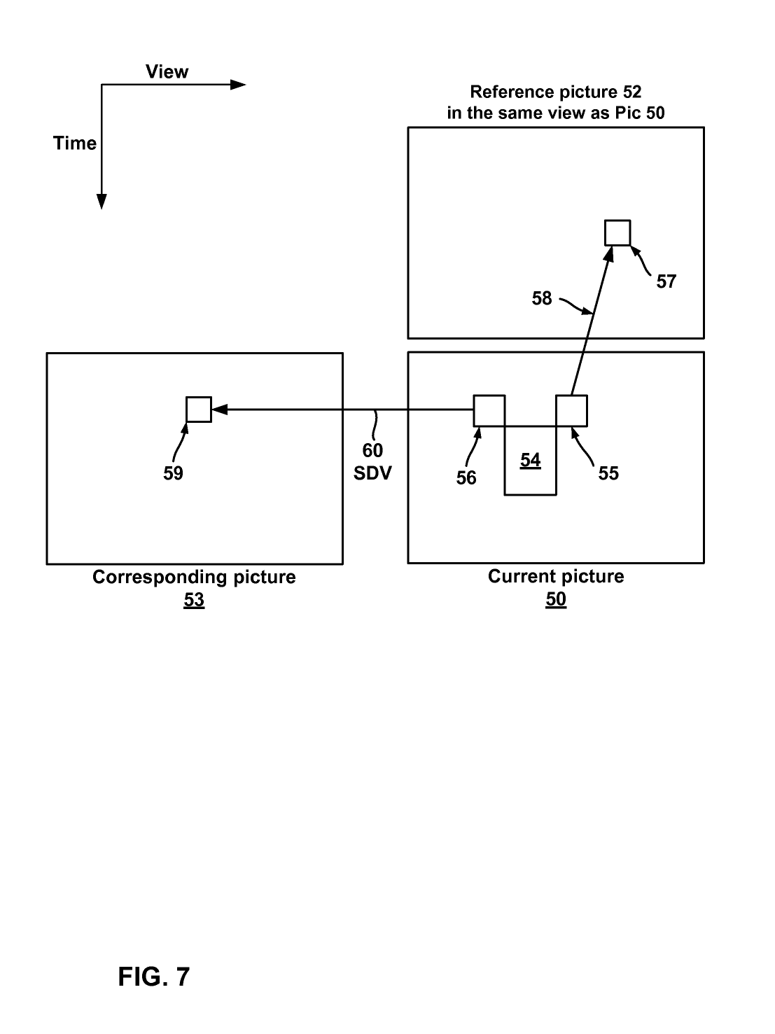

FIG. 7 is a conceptual diagram illustrating an example SDV. FIG. 7 shows three pictures, a current picture 50, a reference picture 52, and a corresponding picture 53. Current picture 50 is a picture currently being coded. Reference picture 52 represents an already-coded picture that is from the same view as current picture 50. Corresponding picture 53 is a picture that corresponds to the same temporal instance as current picture 50 but is in another view. Current picture 50 includes a current video block 54, which is a video block currently being coded. Current block 54 has two spatial neighbors (video block 55 and video block 56) that have already been coded. In the example of FIG. 7, the two spatial neighbors (video block 55 and video block 56) of current video block 54 are coded with motion-compensated prediction (MCP) and disparity-compensated prediction (DCP), respectively. When a video coder predicts a block of video data using a temporal motion vector, the corresponding inter prediction is referred to as motion-compensated prediction (MCP). When a video coder predicts a block of video data using a disparity motion vector, the corresponding inter prediction is referred to as disparity-compensated prediction (DCP). In the example of FIG. 7, video block 55 is coded using MCP, and video block 57 represents the video block used to predict video block 55. Line 58 represents the temporal motion vector used to identify block 57.

In the example of FIG. 7, video block 56 is coded using DCP instead of MCP. Video block 56 is predicted from video block 59, which is in a different view than video block 56. Therefore, the motion vector used to locate the reference block (i.e. video block 59) for video block 56 is a disparity motion vector instead of a temporal motion vector. Line 60 represents the disparity motion vector used to locate block 59. In the example of FIG. 7, line 60 represents an SDV for video block 56. In some implementations, the SDV may be used as a disparity vector for current video block 54. In other implementations, the SDV may be added to disVecCan for current video block 54, and a disparity vector for current video block 54 can be selected from the disparity vector candidates in disVecCan.

To determine SDVs, video encoder 20 and video decoder 30 can check each spatial neighboring prediction unit of current video block 54 in a given order. Current video block 54 may have more spatial neighboring prediction units than just 55 and 56 shown in FIG. 7. FIG. 2, for instance, shows examples of locations covered by other spatial neighboring video blocks. For each of the spatially-neighboring video blocks (e.g., PUs) of current video block 54, a forward motion vector (corresponding to RefPicList0) or a backward motion vector (corresponding to RefPicList1), if available, can be checked and added to the disVecCan if the motion vector is a disparity motion vector. Referring back to FIG. 7, for example, the motion vector represented by line 60 may constitute an SDV for current video block 54 because it is a disparity motion vector, while the motion vector represented by line 58 does not constitute an SDV because it is a temporal motion vector.

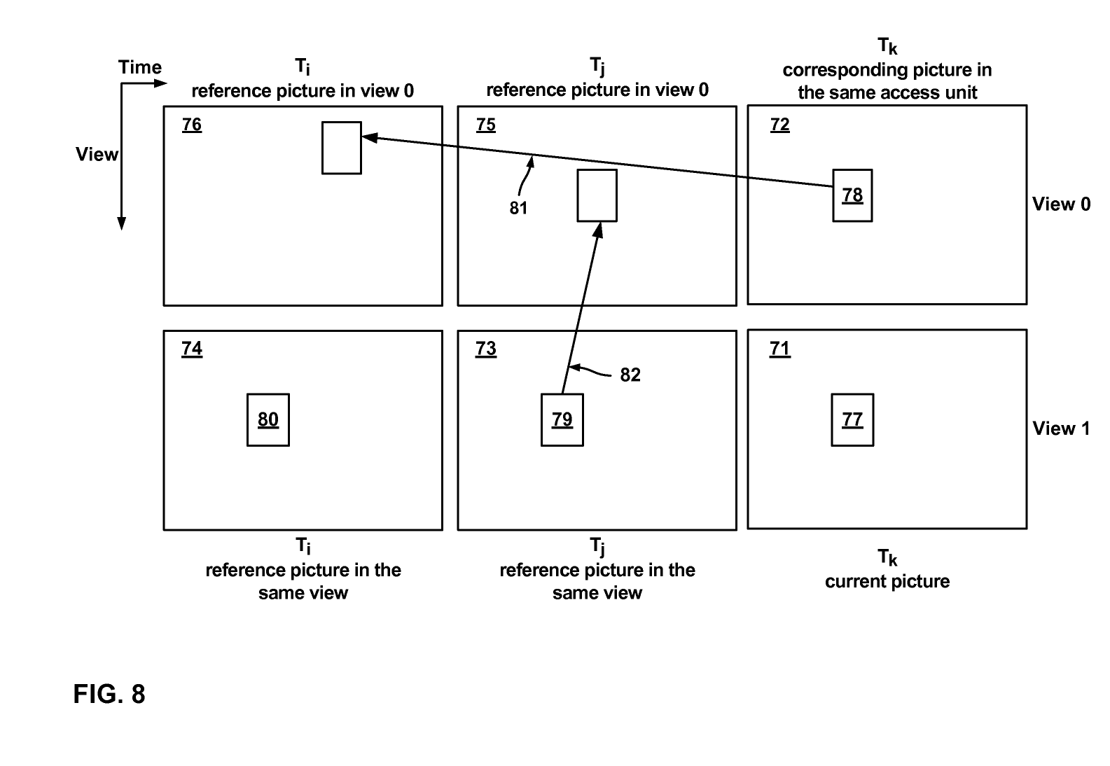

FIG. 8 is a conceptual diagram illustrating an example TDV. FIG. 8 shows six pictures. Current picture 71 is a picture currently being coded. Corresponding picture 72 is a picture that is of the same temporal instance as current picture 71 but in a different view (view 0 in the example of FIG. 8). Reference pictures 73 and 74 represent reference pictures that are in the same view (i.e., view 1) as current picture 71, and reference pictures 75 and 76 represent reference pictures that are in the same view (i.e., view 0) as corresponding picture 72. In the example of FIG. 8, reference picture 74 and reference picture 76 are pictures of the same temporal instance, and reference picture 73 and reference picture 75 are pictures of the same temporal instance.

Current picture 71 includes a current video block 77 currently being coded. There are three reference pictures for current video block 77, two from the same view (reference picture 73 and reference picture 74 in view 1) and one from the other view (corresponding picture 72 in view 0). Three temporal neighboring blocks (78, 79, and 80) can be checked to determine if they use a disparity motion vector. Blocks 78, 79, and 80 are considered temporal neighbors of video block 77 because they are co-located to video block 77, meaning they are in the same approximate location as video block 77 but in different pictures.

In the example of FIG. 8, temporal neighboring block 80 may be intra predicted and does not have an associated motion vector. Temporal neighboring block 78 may be inter predicted using a temporal motion vector, represented in FIG. 8 by line 81. Temporal neighboring block 79 is inter-view predicted using a disparity motion vector represented by line 82. Thus, in the example of FIG. 8, only temporal neighboring block 79 is predicted using a disparity motion vector. Therefore, only the motion vector of temporal neighboring block 79 is used as a TDV candidate. The TDV candidate may either be used as disparity vector for current video block 77 or may be added as a candidate disparity vector to disVecCan, from which a disparity vector for current video block 77 is selected.

Video encoder 20 and video decoder 30 may identify, for use as a TDV, the disparity motion vector of a co-located PU of the first reference picture of reference picture list 0 or reference picture list 1. Video encoder 20 and video decoder 30 may also identify, for use as a TDV, the disparity motion vector of the co-located PU from the picture used for TMVP or the block derived by TMVP. Video encoder 20 and video decoder 30 may also identify, for use as a TDV, the disparity motion vector of the co-located PU of any reference picture of either reference picture list, which may or may not be an inter-view reference picture. In some instances, video encoder 20 and video decoder 30 may also identify, for use as a TDV, the disparity motion vector of blocks in an inter-view picture of the same access unit which is not included in the reference picture lists. In addition, video encoder 20 and video decoder 30 may, for use as a TDV, the disparity motion vector of any PU of the CU containing the co-located PU of any of the above mentioned pictures or the disparity motion vector of any PU of the LCU containing the co-located PU of any of the above-mentioned pictures.

Implicit disparity vectors (IDVs) refer to stored disparity vectors of the neighboring video blocks of the current video block. After coding a current video block, if the disparity vector is used for inter-view prediction, that is, at least one of its motion vectors predicted from inter-view motion parameter prediction, the disparity vector is stored for the current video block. When coding a video block in the future, the previously-stored disparity vectors are used to predict the disparity vector. When checking such previously disparity vectors, also only neighboring video blocks may be checked. This means that disparity vectors of spatial neighboring video blocks (as those containing SDVs) are IDVs, or the disparity vectors of the temporal neighboring video blocks (as those containing TDVs) are considered as IDVs, or disparity vectors of both spatial and temporal neighboring video blocks are considered as IDVs. The described techniques may work with or without considering IDVs.

If a PU is coded with at least one of its motion vectors predicted from inter-view motion parameter prediction, i.e., derived from other views based on a disparity vector, the disparity vector may be temporally associated with the PU. The disparity vector associated with such a PU is referred to as an IDV. When a spatial or temporal neighboring PU of the current PU is contains an IDV, the IDV can be considered for use to derive the disparity vector for the current block. That is, an IDV of a spatial or temporal neighbor PU can be treated as an IDV candidate. The IDV candidate may either be used as a disparity vector for the current block or may be added as a candidate disparity vector to disVecCan, from which a disparity vector for the current block is selected.

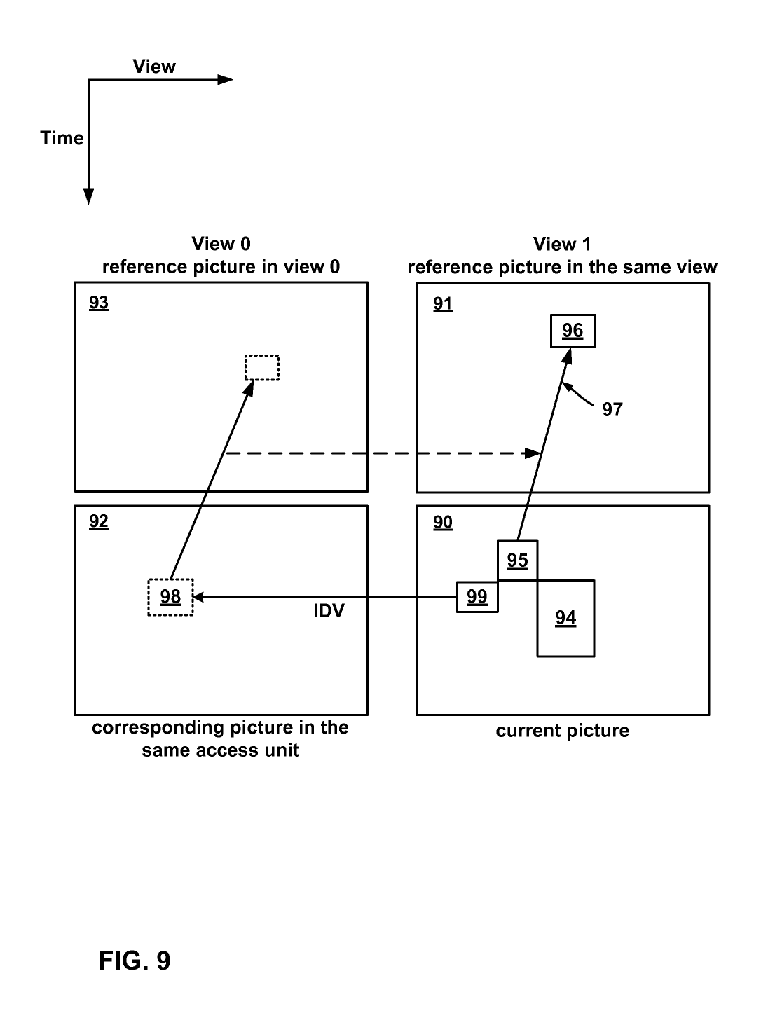

FIG. 9 is a conceptual diagram illustrating an example IDV. In particular, FIG. 9 shows four pictures. Current picture 90 is a picture currently being coded. Picture 91 is a reference picture in the same view (view 1) as picture 90 but in a different temporal instance. Corresponding picture 92 is a picture of the same temporal instance as current picture 90 but in a different view (view 0). Picture 93 is a reference picture in the same view (view 0) as picture 92. In the example of FIG. 9, picture 90 includes a current PU 94. Current PU 94 has a spatial neighbor (PU 95) that is predicted from block 96 in reference picture 91 in the same view (view 1). The motion vector used to predict PU 95 is represented by line 97. In the example of FIG. 9, this motion vector (line 97) is inherited from PU 98. PU 98 is located by the disparity vector of PU 99, which is a spatial neighboring PU of PU 95. In this case, PU 95 is a PU that is associated with an IDV, and the disparity vector of PU 99 is treated as an IDV. Given a target reference view, a disparity vector may be determined for current PU 94 from the available SDV, TDV or IDV vectors described above.

A video coder may apply inter-view motion prediction for both AMVP and merge modes. A video coder may construct a Disparity Vector for Inter-View Motion Prediction (DVIVMP) for each PU. The video coder may use the DVIVMP for a PU for inter-view motion prediction of the PU as described below. For including the inter-view motion prediction, the AMVP mode has been extended in a way that an inter-view motion vector predictor is added to the candidate list. Based on the depth estimate for a middle sample of the current block, a disparity vector and a reference block in a reference view is determined as described above. If the reference index for the current block refers to an inter-view reference picture, the inter-view motion vector predictor is set equal to the corresponding disparity vector. If the current reference index refers to a temporal reference picture and the reference block uses a motion hypothesis that refers to the same access unit as the current reference index, the motion vector that is associated with this motion hypothesis is used as inter-view motion vector predictor. In all other cases, the inter-view motion vector predictor is marked as invalid and is not included in the list of motion vector predictor candidates.

In merge mode and skip mode, the MVP candidate list is extended by a MVP candidate that is obtained using inter-view motion prediction. For each potential motion hypothesis, the first two reference indices of the reference picture list are investigated in the given order. The video coder may derive a motion vector candidate for the reference index 0 in the same way as for the AMVP mode. If the derived motion vector is valid, the video coder may use the reference index 0 and the derived motion vector for the considered hypothesis. Otherwise, the video coder may test the reference index 1 in the same way. If the reference index 1 also results in an invalid motion vector, the video coder may mark the motion hypothesis as not available. In order to prefer temporal prediction, the video coder may reverse the order in which reference indices are tested if the first index refers to an inter-view reference picture. If all potential motion hypotheses are marked as not available, the video coder cannot select the inter-view candidate.

Inter-view residual prediction may be enabled in 3D-HEVC. Based on a depth map that corresponds to a current picture, a video coder may determine a disparity vector for a current block. In some examples, the video coder may estimate the depth map. The video coder may then use the disparity vector to locate a residual block in a reference view. This residual block may be referred to herein as a residual reference block. When residual prediction is enabled for a block, video decoder 30 may reconstruct the current block by adding the residual reference block to a predictive block of the current block and a signaled residual block for the current block.

There are several problems with existing designs of the disparity vector construction process in 3D-HEVC. For example, in existing designs of the disparity vector construction process in 3D-HEVC, disparity vectors are typically derived from the disparity motion vectors. The disparity motion vectors may not be related to the true disparity. As a result, the disparity vectors may be inaccurate. This may be especially true when a disparity vector is used to locate a corresponding block in a different view. In another example, a block preferring inter-view prediction may correspond to a significant disparity. A block preferring inter-view prediction may have more inter-view correlation than temporal correlation, and thus a video encoder is more likely to select inter-view prediction for the block than intra-view prediction. However, the current existing design of the disparity vector construction process in 3D-HEVC mainly considers the first available disparity vector, which might be sub-optimal.

This disclosure describes techniques that may resolve these problems in the existing designs of the disparity vector construction process in 3D-HEVC. In accordance with the techniques of this disclosure, a video coder (e.g., video encoder 20 or video decoder 30) may determine a disparity vector for inter-view prediction (e.g., inter-view motion prediction and inter-view residual prediction) while coding a current view, the video coder may examine disparity vectors in a fashion that certain constraints related to disparity range apply. The examined disparity vectors may include disparity motion vectors from coded spatial and temporal neighboring blocks. Thus, instead of always selecting the first available disparity motion vector, the video coder may select the first available disparity motion vector only when the first available disparity motion vector is within a particular disparity range. Otherwise, if the first available disparity motion vector is not within the particular disparity range, the video coder may jointly consider multiple disparity motion vectors to determine a disparity motion vector that is closest to a most-desirable disparity range.

In accordance with a first example technique of this disclosure, a video coder may determine a disparity range for a pair of views. For example, one determined range may include only values larger than zero. In some examples, the video coder may determine the disparity range from camera parameters. Examples of camera parameters include intrinsic parameters and extrinsic parameters, including relative horizontal locations/displacements of the cameras. Furthermore, the video coder may check spatially- and/or temporally-neighboring blocks according to a pre-defined checking order. When the video coder checks a neighboring block, the video coder may calculate a disparity from a disparity motion vector of the neighboring block. The video coder may then determine whether the calculated disparity is within the disparity range. In response to determining that the calculated disparity is within the disparity range, the video coder may determine that the disparity motion vector of the neighboring block is available. Otherwise, in response to determining that the calculated disparity is not within the disparity range, the video coder may determine that the disparity motion vector of the neighboring block is unavailable. The video coder may stop checking neighboring blocks in response to determining that the disparity motion vector of the neighboring block is available. For instance, if and only if a disparity motion vector is available, the derivation process successfully terminates.

In this way, the video coder may determine that a first available disparity vector candidate is outside an expected range. Furthermore, the video coder may determine that a disparity vector for a current PU is equal to a second available disparity vector candidate when the first available disparity vector candidate is outside the expected range. The first and second available disparity vector candidates may be associated with PUs that spatially or temporally neighbor the current PU. Each of the first and second available disparity vector candidates is a SDV, a TDV, or an IDV of a respective PU that spatially or temporally neighbors the current PU.

In some instances, the disparity range may be limited to values greater than or equal to 0. In other words, the range of the disparity may be expected to be larger than or equal to 0. In such instances, the video coder may determine that a disparity motion vector is available if a horizontal value (i.e., a disparity) of the disparity motion vector is greater than or equal to 0. In other words, only when a disparity motion vector which has a horizontal value larger than or equal to 0 is considered available.

In other instances, the disparity range may be limited to values less than or equal to 0. In other words, the range of the disparity may be expected to be all values smaller than or equal to 0. In such instances, the video coder may determine that a disparity motion vector is available if a horizontal value (i.e., a disparity) of the disparity motion vector is less than or equal to 0. In other words, only a disparity motion vector which has a horizontal value smaller than or equal to 0 is considered to be available.

In accordance with a second example technique of this disclosure, a video coder may check spatially and/or temporally neighboring video blocks (e.g., spatially- and/or temporally-neighboring PUs) according to a pre-defined checking order. When the video coder checks a neighboring video block, the video coder may determine whether a disparity motion vector of the neighboring video block is available. If the disparity motion vector of the neighboring video block is available, the video coder may record the disparity motion vector. In contrast to the first example technique described above, the video coder may, in this second example technique, check each neighboring video block according to the pre-defined checking order, regardless of whether the video coder determines that a neighboring video block has an available disparity motion vector. In this way, all available disparity motion vectors may be recorded.

In the second example technique of this disclosure, the video coder may review the recorded available disparity motion vectors and determine, from among the recorded available disparity motion vectors, a recorded available disparity motion vector that corresponds to an object closest in distance to the camera/viewpoint. In other words, the disparity motion vector corresponding to the closest object may be returned as the final disparity vector. In one example, the video coder may determine that disparity motion vectors with larger horizontal components correspond to closer objects. In other examples, the video coder may determine that disparity motion vectors with larger horizontal components correspond to farther objects. The video coder may use a horizontal component of the determined disparity motion vector as a disparity vector of a current video block (e.g., a current PU).

In another version of the second example technique of this disclosure, the video coder may record a disparity motion vector only when the disparity motion vector is within a particular range. The video coder may determine the particular range in the manner described with regard to the first example technique of this disclosure.

In accordance with a third example technique of this disclosure, a video coder may check spatially and/or temporally neighboring video blocks (e.g., spatially- and/or temporally-neighboring PUs) according to a pre-defined checking order. When the video coder checks a neighboring video block, the video coder may determine whether a disparity motion vector of the neighboring video block is available. If the disparity motion vector of the neighboring video block is available, the video coder may record the disparity motion vector. In this way, all the available disparity motion vectors may be recorded. The video coder may then determine, from among the recorded available disparity motion vectors, a disparity motion vector that corresponds to an object with a farthest distance to the camera/viewpoint. The video coder may determine, based at least in part on the determined disparity motion vector, a disparity vector of a current video block (e.g., a current PU). In other words, the disparity motion vector corresponding to the farthest object is returned as the final disparity vector.

In another version of the third example technique of this disclosure, the video coder may record a disparity motion vector only when the disparity motion vector is within a particular range. The video coder may determine the particular range in the manner described with regard to the first example technique of this disclosure.

In the first, second, and third example techniques described above, the video coder may determine, based at least in part on camera parameters or camera locations of views, the depth ranges (i.e., the ranges of the real-world distance between objects and the camera/viewpoint). For instance, in the first, second, and third example techniques described above, the video coder may only need to determine, for a current view and a reference view, whether a larger or a smaller disparity is preferred, implying during the decoding process, a relative larger or smaller disparity vector among the candidates can provide better representation of the disparity of the current block and thus higher coding efficiency. For example, when cameras are in parallel without sensor shift and the current view is to the right of the reference view, the disparity may typically be positive. In short, a sensor shift configured camera setting corresponds to parallel cameras with intrinsic cameras containing shifted principle axis for the projection of the 3D scene into the 2D plane such that parallax can be created. Thus, in this example, larger disparity may be preferred. When the cameras are in parallel without sensor shift and the current view is to the left of the reference view, the disparity may typically be negative. Thus, in this example, smaller disparity may be preferred.

In accordance with a fourth example technique of this disclosure, a video coder may check spatially and/or temporally neighboring video blocks according to a pre-defined checking order. When the video coder checks a neighboring video block, the video coder may determine whether a disparity motion vector of the neighboring video block is available. If the disparity motion vector of the neighboring video block is available, the video coder may record the disparity motion vector. In this way, all the available disparity motion vectors may be recorded. Subsequently, the video coder may determine the number of the recorded available disparity motion vectors having horizontal components that fall within a first range and the video coder may also determine the number of the recorded available disparity motion vectors having horizontal components that fall within a second range. The first range may correspond to closer objects and the second range may correspond to farther objects. In other words, for two given disparity ranges, namely a closer range and a farther range, the video coder may count the number of disparity motion vectors falling into each range.

Next, in the fourth example technique of this disclosure, the video coder may select, from among the first range and the second range, a range that includes the most disparity motion vectors. In other words, the range that has a larger number of candidates is selected. If the horizontal components of the disparity motion vectors of the selected range are smaller than the horizontal components of the disparity motion vectors of the non-selected range, the video coder may determine, from among the disparity motion vectors in the selected range, a disparity motion vector that has a smallest horizontal component. Otherwise, if the horizontal components of the disparity motion vectors of the selected range are not smaller than the horizontal components of the disparity motion vectors of the non-selected range, the video coder may determine, from among the disparity motion vectors in the selected range, a disparity motion vector that has a largest horizontal component. The video coder may determine, based at least in part on the determined disparity motion vector, a disparity vector of a current video block (e.g., a current PU). In other words, for the selected range, if the selected range has smaller disparity values than the other range, the video coder may return the disparity motion vector in this selected range that has the smallest disparity motion vector (considering only the horizontal part of the vector), otherwise, the video coder may return the disparity motion vector in this selected range that has the largest disparity motion vector.

In another version of the fourth example technique of this disclosure, the video coder may record a disparity motion vector only when the disparity motion vector is within a particular disparity range. The video coder may determine the particular disparity range in the manner described with regard to the first example technique of this disclosure.

In this fourth example technique of this disclosure, the disparity range may be predefined. For example, when a parallel camera setting with sensor shift is used, [−10, 0] might be the farther disparity range and [0, 20] might be the closer disparity range. The video coder may use the farther disparity range to capture the disparity corresponding to an object popped out of the screen. The video coder may use the closer disparity range to capture the disparity corresponding to an object inside the screen. Thus, if a majority of the available disparity motion vectors is close to a viewer, the video coder may return a disparity motion vector even closer to the viewer. If a majority of the available disparity motion vectors is farther from the viewer, the video coder may return a disparity motion vector even farther from the viewer.

A fifth example technique of this disclosure is similar to the second, third, and fourth example techniques described above. However, in the fifth example technique, the video coder only records the disparity motion vectors of video blocks (e.g., PUs) that spatially neighbor a current video block (e.g., a current PU). The video coder does not record the disparity motion vectors of video blocks that temporally neighbor the current video block. The video coder may determine, from among the recorded available disparity motion vectors, a disparity motion vector. The video coder may then determine, based at least in part on the determined disparity motion vector, a disparity vector for the current video block. In this way, the disparity motion vectors from only spatial neighboring blocks are recorded and used to return a selected disparity vector. If the video coder does not determine any available disparity motion vectors, the video coder may check other sources of disparity vectors, such as disparity vectors that have been derived and stored in the neighboring blocks, or disparity motion vectors in other blocks. When the video coder checks the other disparity motion vectors, the video coder may determine, based at least in part on a first-available one of the other disparity motion vectors, a disparity vector for the current video block. In other words, if the process of the fifth example technique does not return an available disparity vector, other disparity motion vectors are checked and the first available one is returned as the disparity vector.

A sixth example technique of this disclosure is similar to the second, third and fourth example techniques described above. However, in the sixth example technique of this disclosure, the video coder only records the disparity motion vectors from video blocks (e.g., PUs) that spatially neighbor a current video block (e.g. a current PU) and disparity motion vectors from a subset of the video blocks that temporally neighbor the current video block. A subset of the neighboring video blocks may be chosen e.g., in a way similar to the blocks used for AMVP and merge modes in HEVC. That is, only the disparity motion vectors from spatially-neighboring blocks and a subset of temporally-neighboring blocks are recorded and used to return a selected disparity vector. If the video coder does not determine any available disparity motion vector, the video coder may check other sources of disparity vectors, such as disparity vectors that have been derived and stored in the neighboring blocks, or disparity motion vectors in other blocks. When the video coder checks the other disparity motion vectors, the video coder may determine, based at least in part on a first-available one of the other disparity motion vectors, a disparity vector for the current video block. In other words, if the process of the sixth example technique does not return an available disparity vector, other disparity motion vectors are checked and the first available one is returned as the disparity vector.

A seventh example technique of this disclosure is similar to the second, third and fourth example techniques described above. However, in the seventh example technique of this disclosure, there may be a pre-defined number of disparity motion vectors to be recorded. The pre-defined number of disparity motion vectors to be recorded may be denoted as “N.” In the seventh example technique of this disclosure, the video coder may record the first N available disparity motion vectors and the video coder may select a disparity vector from among the recorded disparity motion vectors. If the number of available disparity motion vectors is smaller than N, all of them are recorded and the video encoder may select the disparity vector from among the recoded disparity motion vectors.

An eighth example technique of this disclosure is similar to the second, third, and fourth example techniques described above. However, in the eighth example technique of this disclosure, there may be a pre-defined number of disparity motion vectors to be checked. The pre-defined number of disparity motion vectors to be checked may be denoted as “N.” If the video coder has checked all possible disparity motion vectors or the number of checked disparity motion vectors is equal to N and larger than 0, the video coder may apply the method described according to one of the first, second, or third example techniques described above to determine a disparity vector for a current block. Otherwise, if the video coder has checked all possible disparity motion vectors and the number of checked disparity motion vectors is not equal to N or not larger than 0, the video coder may check other sources of disparity vectors, such as disparity vectors that have been derived and stored in the neighboring blocks, or disparity motion vectors in other blocks. When the video coder checks the other disparity motion vectors, the video coder may select a first-available one of the other disparity motion vectors and may determine, based at least in part on the selected disparity motion vector, the disparity vector for the current video block.

In a ninth example technique of this disclosure, a video coder may use different disparity vector generation methods for different inter-view predictions. A disparity vector generation method (i.e., a disparity vector derivation process) is a method or process used to determine a disparity vector. For example, the video coder may use a first disparity vector generation method for inter-view residual prediction and may use a second disparity vector generation method for inter-view motion prediction. Furthermore, a video coder may use different disparity vector generation methods for different non-base views. For example, the video coder may use a first disparity vector generation method for a first view and a second disparity vector generation method for a second view.

Thus, in the ninth example technique, video encoder 20 may determine a first disparity vector using a first disparity vector derivation process. In addition, video encoder 20 may determine a second disparity vector using a second disparity vector derivation process. The first disparity vector derivation process may be different than the second disparity vector derivation process. Video encoder 20 may use the first disparity vector to determine a MVP candidate in a set of MVP candidates for a current PU. Video encoder 20 may use the second disparity vector to determine residual data. Furthermore, video encoder 20 may generate a bitstream that includes data indicating the residual data for the current PU and a selected MVP candidate in the set of MVP candidates.

Similarly, in the ninth example technique, video decoder 30 may determine a first disparity vector using a first disparity vector derivation process. In addition, video decoder 30 may determine a second disparity vector using a second disparity vector derivation process. The first disparity vector derivation process may be different than the second disparity vector derivation process. Furthermore, video decoder 30 may use the first disparity vector to determine a MVP candidate in a set of MVP candidates for a current PU. Video decoder 30 may use the second disparity vector to determine residual data. In addition, video decoder 30 may generate, based in part on the residual data and a selected MVP candidate in the set of MVP candidates, one or more blocks of a reconstructed picture.

Moreover, in some examples, a video coder may use different disparity vector generation methods for different modes of inter-view motion prediction. For example, the video coder may use a first disparity vector generation method for AMVP mode and the video coder may use a second disparity vector generation method for merge mode. Thus, a video coder (e.g., video encoder 20 or video decoder 30) may use different disparity vector derivation processes to determine a disparity vector depending on whether the motion information of a current PU is encoded using a first mode (e.g., merge mode) or a second mode (e.g., AMVP mode). The video coder may use this disparity vector to determine a MVP.

For example, video encoder 20 may generate a set of MVP candidates and generate a bitstream that includes a candidate index that indicates a selected MVP candidate in the set of MVP candidates. The selected MVP candidate specifies a motion vector for a current PU when the motion information of the current PU is encoded using the first mode (i.e., merge mode). In this example, when the motion information of the current PU is encoded using the second mode (i.e., AMVP mode), video encoder 20 may include, in the bitstream, data indicating a MVD for the current PU. The MVD for the current PU indicates a difference between a motion vector indicated by the selected MVP candidate and a motion vector of the current PU.

In another example, video decoder 30 may obtain, from a bitstream, a candidate index and generate a set of MVP candidates. Video decoder 30 may determine, based at least in part on the candidate index, a selected MVP candidate in the set of MVP candidates. The selected MVP candidate may specify a motion vector for a current PU when the motion information of the current PU is encoded using the first mode (i.e., merge mode). When the motion information of the current PU is encoded using the second mode (i.e., AMVP mode), video decoder 30 may obtain, from the bitstream, a MVD for the current PU and determine, based at least in part on a motion vector indicated by the selected MVP candidate and the MVD, the motion vector of the current PU. In some examples, video decoder 30 may determine, based at least in part on the selected MVP candidate, a predictive block for the current PU. Video decoder 30 may generate, based at least in part on the predictive block for the current PU and the residual data, a reconstructed block.

A tenth example technique of this disclosure is similar to the first, second, and third example techniques described above. However, in the tenth example technique of this disclosure, video encoder 20 may signal a syntax element (e.g., a flag) for a particular view and a reference view of the particular view. The syntax element may indicate whether a larger disparity is preferred (i.e., to be chosen when multiple disparity vectors are available for selection). In different examples, video encoder 20 may signal the flag in a slice header, a PPS, a sequence parameter set (SPS), or a video parameter set (VPS). A VPS is a syntax structure that may contain syntax elements that apply to zero or more entire coded video sequences. A SPS is a syntax structure that may contain syntax elements that apply to zero or more entire coded video sequences. A single VPS may be applicable to multiple SPSs. In some examples, if the syntax element has a value equal to 1 and a video coder uses the first example technique as described above, the video coder may only consider positive disparity motion vectors to be available. In other examples, if the syntax element has a value equal to 1 and a video coder uses the second example technique as described above, the video coder may select the disparity motion vector having the maximum horizontal value.

Alternatively, in the tenth example technique, video encoder 20 may signal a first indication and a second indication. The first indication may indicate whether cameras are arranged from left to right in an increasing or decreasing order of view identifier. The second indication may indicate whether the view identifiers are increasing or decreasing. In some examples, the second indication is part of the first indication. Thus, for a particular pair of views, video decoder 30 may determine, based on the first and second indications, whether a larger disparity or a smaller disparity is preferred (i.e., to be chosen when multiple disparity vectors are available for selection).

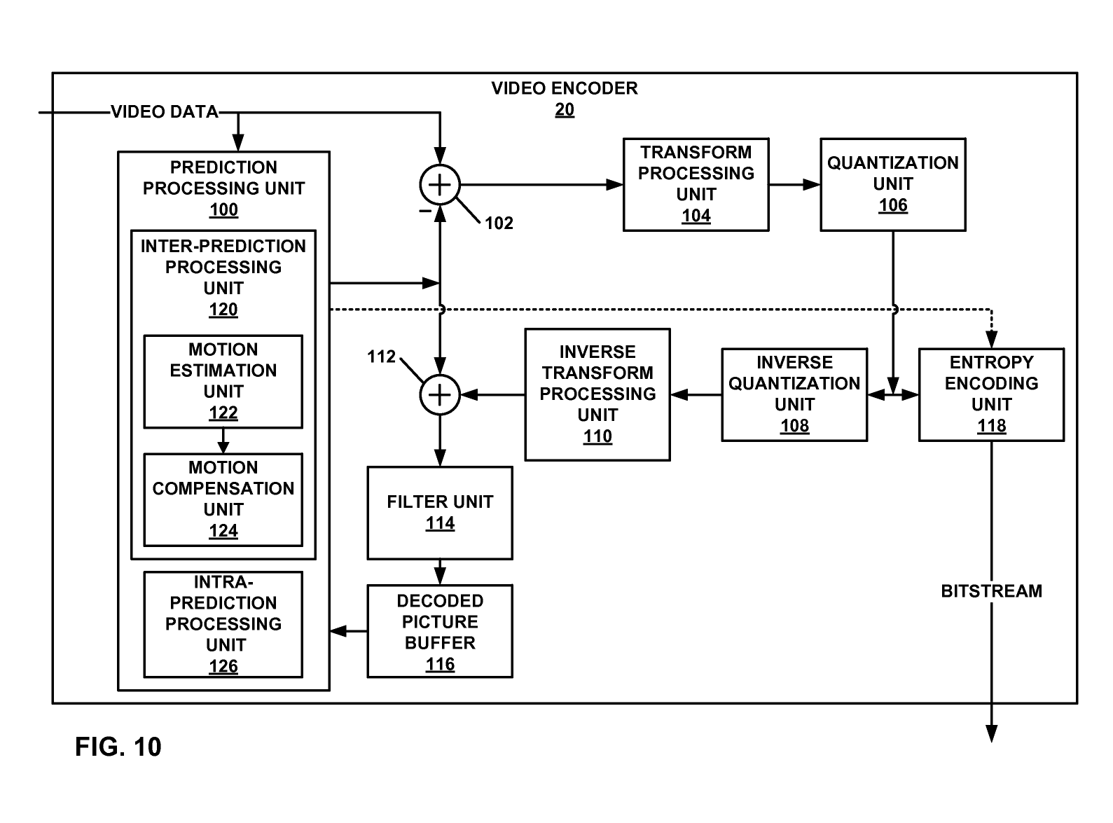

FIG. 10 is a block diagram illustrating an example video encoder 20 that may implement the techniques of this disclosure. FIG. 10 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 10, video encoder 20 includes a prediction processing unit 100, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit 122 and a motion compensation unit 124. In other examples, video encoder 20 may include more, fewer, or different functional components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform quad-tree partitioning to divide the CTBs of the CTU into progressively-smaller blocks. The smaller blocks may be coding blocks of CUs. For example, prediction processing unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. The size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU by performing inter prediction on each PU of a CU. The predictive data for the PU may include a predictive blocks of the PU and motion information for the PU. Inter-prediction processing unit 120 may perform different operations for a PU of a CU depending on whether the PU is in an I slice, a P slice, or a B slice. In an I slice, all PUs are intra predicted. Hence, if the PU is in an I slice, inter-prediction processing unit 120 does not perform inter prediction on the PU. Thus, for video blocks encoded in I-mode, the predictive block is formed using spatial prediction from previously-encoded neighboring blocks within the same frame.

PUs is in a P slice may be intra predicted or uni-directionally inter predicted. For instance, if a PU is in a P slice, motion estimation unit 122 may search the reference pictures in a list of reference pictures (e.g., “RefPicList0”) for a reference region for the PU. The reference region for the PU may be a region, within a reference picture, that contains sample blocks that most closely corresponds to the prediction blocks of the PU. Motion estimation unit 122 may generate a reference index that indicates a position in RefPicList0 of the reference picture containing the reference region for the PU. In addition, motion estimation unit 122 may generate a motion vector that indicates a spatial displacement between a prediction block of the PU and a reference location associated with the reference region. For instance, the motion vector may be a two-dimensional vector that provides an offset from the coordinates in the current decoded picture to coordinates in a reference picture. Motion estimation unit 122 may output the reference index and the motion vector as the motion information of the PU. Motion compensation unit 124 may generate the predictive blocks of the PU based on actual or interpolated samples at the reference location indicated by the motion vector of the PU.

PUs in a B slice may be intra predicted, uni-directionally inter predicted, or bi-directionally inter predicted. Hence, if a PU is in a B slice, the motion estimation unit 122 may perform uni-prediction or bi-prediction for the PU. To perform uni-prediction for the PU, motion estimation unit 122 may search the reference pictures of RefPicList0 or a second reference picture list (“RefPicList1”) for a reference region for the PU. Motion estimation unit 122 may output, as the motion information of the PU, a reference index that indicates a position in RefPicList0 or RefPicList1 of the reference picture that contains the reference region, a motion vector that indicates a spatial displacement between a prediction block of the PU and a reference location associated with the reference region, and one or more prediction direction indicators that indicate whether the reference picture is in RefPicList0 or RefPicList1. Motion compensation unit 124 may generate the predictive blocks of the PU based at least in part on actual or interpolated samples at the reference region indicated by the motion vector of the PU.

To perform bi-directional inter prediction for a PU, motion estimation unit 122 may search the reference pictures in RefPicList0 for a reference region for the PU and may also search the reference pictures in RefPicList1 for another reference region for the PU. Motion estimation unit 122 may generate reference indexes that indicate positions in RefPicList0 and RefPicList1 of the reference pictures that contain the reference regions. In addition, motion estimation unit 122 may generate motion vectors that indicate spatial displacements between the reference locations associated with the reference regions and a prediction block of the PU. The motion information of the PU may include the reference indexes and the MVs of the PU. Motion compensation unit 124 may generate the predictive blocks of the PU based at least in part on actual or interpolated samples at the reference region indicated by the motion vector of the PU.

Intra-prediction processing unit 126 may generate predictive data for a PU by performing intra prediction on the PU. The predictive data for the PU may include predictive blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may generate a predictive block for a PU based on samples of neighboring PUs. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes. In some examples, the number of intra prediction modes may depend on the size of the prediction blocks of the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the luma, Cb and Cr coding blocks of a CU and the selected predictive luma, Cb and Cr blocks of the PUs of the CU, a luma, Cb and Cr residual blocks of the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may perform quad-tree partitioning to partition the residual blocks associated with a CU into transform blocks associated with TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU. The bitstream may also include syntax elements that are not entropy encoded.

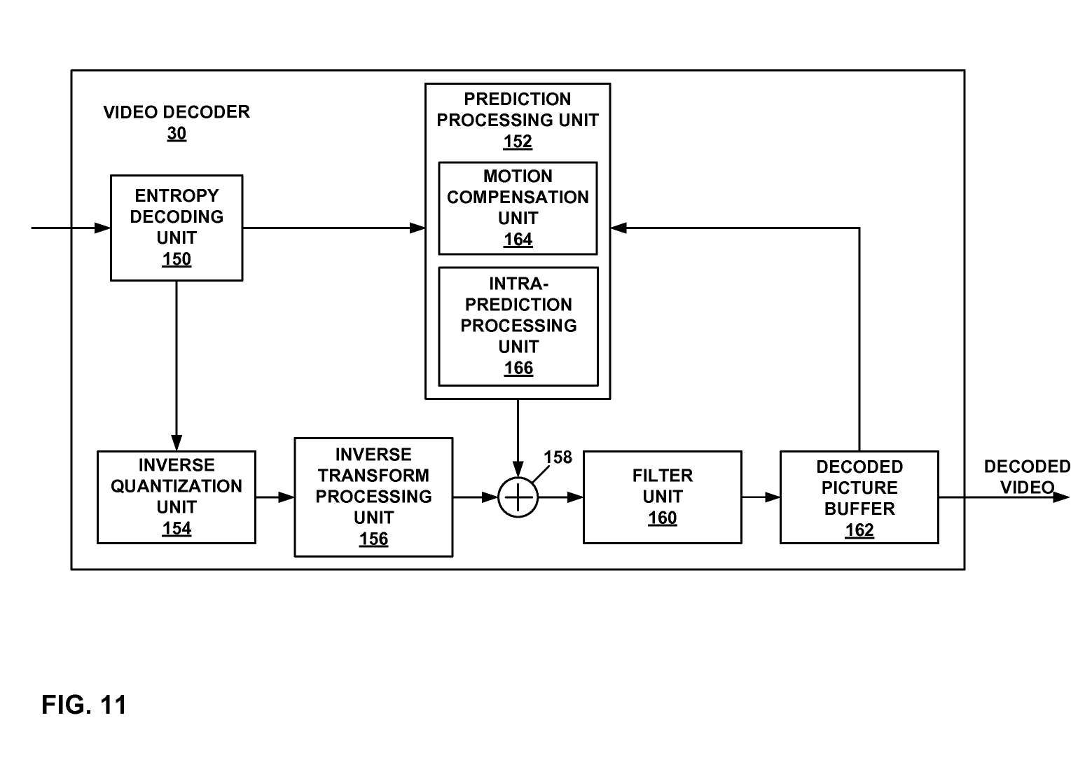

FIG. 11 is a block diagram illustrating an example video decoder 30 that may implement the techniques described in this disclosure. FIG. 11 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 11, video decoder 30 includes an entropy decoding unit 150, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

Entropy decoding unit 150 may receive NAL units and parse the NAL units to decode syntax elements. Entropy decoding unit 150 may entropy decode entropy-encoded syntax elements in the NAL units. Prediction processing unit 152, inverse quantization unit 154, inverse transform processing unit 156, reconstruction unit 158, and filter unit 160 may generate decoded video data based on the syntax elements extracted from the bitstream.

The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform reconstruction operations on CUs. To perform the reconstruction operation on a CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive luma, Cb and Cr blocks for the PU based on the prediction blocks of spatially-neighboring PUs. Intra-prediction processing unit 166 may determine the intra prediction mode for the PU based on one or more syntax elements decoded from the bitstream.

Prediction processing unit 152 may construct a first reference picture list (RefPicList0) and a second reference picture list (RefPicList1) based on syntax elements extracted from the bitstream. Furthermore, if a PU is encoded using inter prediction, entropy decoding unit 150 may extract motion information for the PU. Motion compensation unit 164 may determine, based on the motion information of the PU, one or more reference regions for the PU. Motion compensation unit 164 may generate, based on samples blocks at the one or more reference blocks for the PU, predictive luma, Cb and Cr blocks for the PU.

Reconstruction unit 158 may use the luma, Cb and Cr transform blocks associated with TUs of a CU and the predictive luma, Cb and Cr blocks of the PUs of the CU, i.e., either intra-prediction data or inter-prediction data, as applicable, to reconstruct the luma, Cb and Cr coding blocks of the CU. For example, reconstruction unit 158 may add samples of the luma, Cb and Cr transform blocks to corresponding samples of the predictive luma, Cb and Cr blocks to reconstruct the luma, Cb and Cr coding blocks of the CU.

Filter unit 160 may perform a deblocking operation to reduce blocking artifacts associated with the luma, Cb and Cr coding blocks of the CU. Video decoder 30 may store the luma, Cb and Cr coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the luma, Cb and Cr blocks in decoded picture buffer 162, intra prediction or inter prediction operations on PUs of other CUs. In this way, video decoder 30 may parse, from the bitstream, transform coefficient levels of the luma coefficient block, inverse quantize the transform coefficient levels, apply a transform to the transform coefficient levels to generate a transform block, generate, based at least in part on the transform block, a coding block, and output the coding block for display.

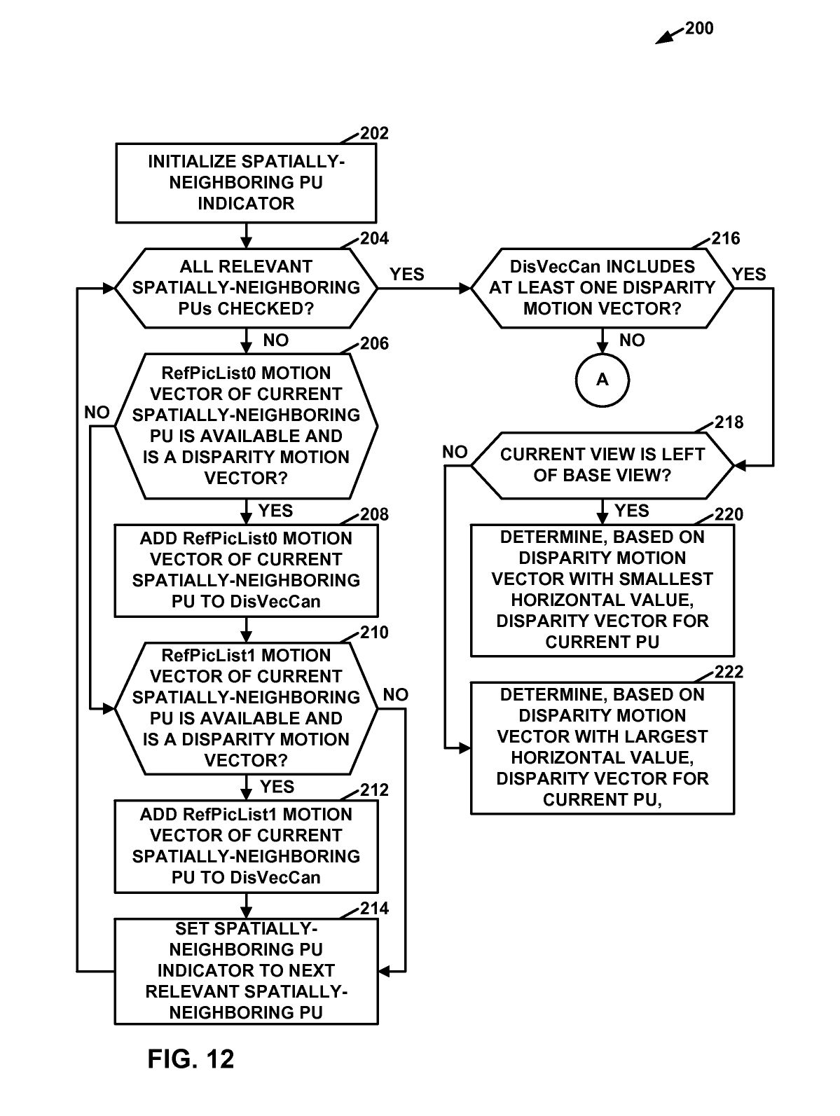

FIG. 12 is a flowchart illustrating an example operation 200 of a video coder to determine a disparity vector for a current PU for use in AMVP, merge mode motion vector prediction, and inter-view residual prediction. Operation 200 may be performed by a video encoder (e.g., video encoder 20), a video decoder (e.g., video decoder 30), or another device. The video coder may perform operation 200 for a view V1 and may also perform operation 200 for a view V2. A base view may be denoted as view V0. View V1 may be to the left of view V0 and view V2 may be to the right of view V0. Furthermore, with regard to operation 200, a disparity vector candidate list may be denoted as disVecCan. In some examples, a disparity vector can be directly used for inter-view motion prediction and inter-view residual prediction. In addition, the vertical part of the disparity vector can be set to 0 when it is used for the AMVP mode and treated as a predictor for inter-view reference pictures.

In the example of FIG. 12, the video coder may initialize a spatially-neighboring PU indicator such that the spatially-neighboring PU indicator indicates a first relevant spatially-neighboring PU according to a checking order (202). In some examples, the relevant spatially-neighboring PUs may be PUs that cover locations A₀, A₁, B₀, B₁, and B₂, as shown in the example of FIG. 2. In some examples, the video coder may check the relevant spatially-neighboring PUs according to the following order of locations: A₁, B₁, B₀, A₀, and B₂. Thus, the video coder may check the spatial neighboring prediction unit N (with N being replaced by A₁, B₁, B₀, A₀ and B₂ in order).

Furthermore, the video coder may determine whether all of the relevant spatially-neighboring PUs have been checked (204). In response to determining that the video coder has not yet checked all of the relevant spatially-neighboring PUs (“NO” of 204), the video coder may determine whether a RefPicList0 motion vector of the current spatially-neighboring PU is available and is a disparity motion vector (206). The current spatially-neighboring PU may be the PU indicated by the spatially-neighboring PU indicator. In general, a RefPicList0 motion vector of a PU is a motion vector of the PU that indicates a location in a reference picture indicated in a RefPicList0 reference index of the PU. The RefPicList0 reference index of a PU is a reference index that indicates a reference picture in RefPicList0. The video coder may determine that a motion vector of a PU is available if the motion vector is specified for the PU. In response to determining that the RefPicList0 motion vector of the current spatially-neighboring PU is available and is a disparity motion vector (“YES” of 206), the video coder may add the RefPicList0 motion vector of the current spatially-neighboring PU to disVecCan (208).

Regardless of whether the RefPicList0 motion vector of the current spatially-neighboring PU is available and is a disparity motion vector, the video coder may determine whether a RefPicList1 motion vector of the current spatially-neighboring PU is available and is a disparity motion vector (210). In general, a RefPicList1 motion vector of a PU is a motion vector of the PU that indicates a location in a reference picture indicated in a RefPicList1 reference index of the PU. The RefPicList1 reference index of a PU is a reference index that indicates a reference picture in RefPicList1. In response to determining that the RefPicList1 motion vector of the current spatially-neighboring PU is available and is a disparity motion vector (“YES” of 210), the video coder may add the RefPicList1 motion vector of the current spatially-neighboring PU to disVecCan (212).

After adding the RefPicList1 motion vector to disVecCan or in response to determining that the RefPicList1 motion vector is not available or not a disparity motion vector (“NO” of 210), the video coder may set the spatially-neighboring PU indicator to indicate a next relevant spatially-neighboring PU according to the checking order (214). The video coder may then determine again whether all of the relevant spatially-neighboring PUs have been checked (204).

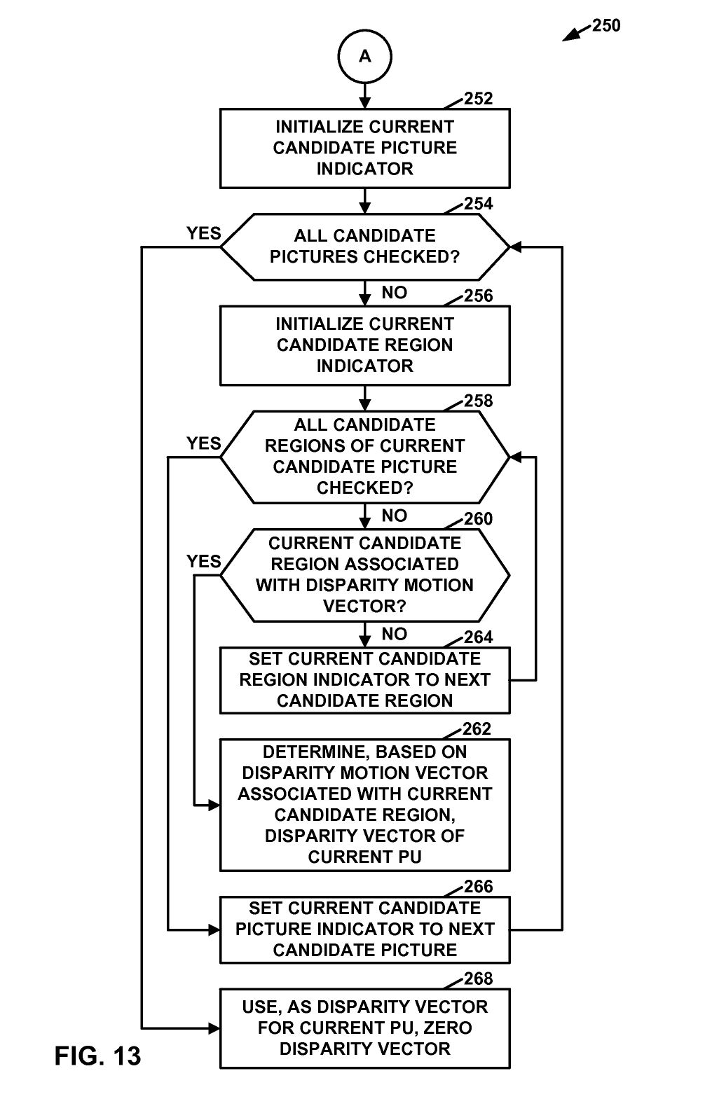

In response to determining that all of the relevant spatially-neighboring PUs have been checked (“YES” of 204), the video coder may determine whether disVecCan includes at least one disparity motion vector (216). In response to determining that disVecCan does not include any disparity motion vectors (“NO” of 216), the video coder may perform a process (denoted as “A” in FIG. 12) that derives a disparity vector for the current PU from temporally-neighboring PUs. FIG. 13, described elsewhere in this disclosure, is a flowchart illustrating an example operation to derive a disparity vector for the current PU from temporally-neighboring PUs.

Otherwise, in response to determining that disVecCan includes at least one disparity motion vector (“YES” of 216), the video coder may determine whether a current view is to the left of the base view (218). In other words, the video coder may determine that the current view is view V1. In response to determining that the current view is to the left of the base view (“YES” of 218), the video coder may determine, based on the disparity motion vector in disVecCan having a smallest horizontal value, the disparity vector for the current PU (220). For instance, the video coder may determine that the disparity vector for the current PU is equal to a horizontal component of the RefPicList0 motion vector of the current spatially-neighboring PU. Otherwise, in response to determining that the current view is not to the left of the base view (“NO” of 218), the video coder may determine, based on the disparity motion vector in disVecCan having a largest horizontal value, the disparity vector for the current PU (222).

In this way, for each neighboring PU N, both forward and backward motion vectors (i.e., motion vectors corresponding to RefPicList0 and RefPicList1, respectively), if available, are checked and added to disVecCan if the motion vector is a disparity motion vector. This disclosure may refer to a motion vector that indicates a reference picture in RefPicList0 as a forward motion vector and may refer to a motion vector that indicates a reference picture in RefPicList1 as a backward motion vector. In response to determining that a spatially-neighboring PU has a disparity motion vector, the video coder may include the disparity vector in a disparity vector candidate list (disVecCan).

After checking the spatially-neighboring PUs, the video coder may determine whether disVecCan includes any disparity motion vectors. In response to determining that disVecCan does not include any disparity motion vectors, the video coder may perform a derivation process for temporal disparity vectors. Otherwise, in response to determining that disVecCan includes at least one disparity motion vector, the video coder may select a disparity vector from among the disparity motion vectors in disVecCan. If the current view is view V1, the video coder may return the disparity vector which has the smallest horizontal value of all entries in disVecCan. Otherwise (the current view is view V2), the video coder may return the disparity vector which has the largest horizontal value of all entries in disVecCan.

FIG. 13 is a flowchart illustrating an example operation 250 to determine a disparity vector for a current PU based on temporally-neighboring PUs. Operation 250 may be performed by a video encoder (e.g., video encoder 20), a video decoder (e.g., video decoder 30), or another device. Operation 250 may be part of operation 200 denoted in FIG. 12 as “A.” As indicated above with regard to FIG. 12, when disVecCan does not include any disparity motion vectors, the video coder may perform a derivation process for temporal disparity vectors, such as operation 250.

As illustrated in the example of FIG. 13, the video coder may initialize a current candidate picture indicator such that the current candidate picture indicator indicates a co-located reference picture from the current view (252). If the current slice (i.e., the slice containing the current PU) is in a B slice and a collocated_from_{—}10 flag syntax element in a slice header of the current slice indicates that the co-located reference picture is in RefPicList1, the co-located reference picture may be the reference picture in RefPicList1 at a location indicated by a collocated_ref_idx syntax element of the slice header. Otherwise, if the current slice is a P slice or the current slice is a B slice and the collocated_from_{—}10 flag syntax element in the slice header of the current slice indicates that the co-located reference picture is in RefPicList0, the co-located reference picture may be the reference picture in RefPicList0 at a location indicated by the collocated_ref_idx syntax element of the slice header. The candidate picture indicated by the current candidate picture indicator may be referred to herein as the current candidate picture.

Furthermore, in the example of FIG. 13, the video coder may determine whether all of the candidate pictures have been checked (254). When the video coder has not yet checked all of the candidate pictures, the video coder may check the current candidate picture. When the video coder checks the current candidate picture, the video coder may check three candidate regions within the current candidate picture. The first candidate region is a co-located PU (CPU) region. The second candidate region is a co-located LCU region. The third candidate region is a bottom right (BR) region. The CPU region is a region, within the current candidate picture, that is co-located with the current PU (or the current CU). The CLCU region is a region, within the current candidate picture, that is associated with an LCU (i.e., CTU) that covers the region, within the current candidate picture, that is co-located with the current PU. The BR region is a 4×4 region, within the current candidate picture, that is located immediately below and immediately right of the CPU region. Thus, the three candidate regions may be defined as follows:
CPU: The co-located region of the current PU or current CU.
CLCU: The LCU covering the co-located region of the current PU.
BR: Bottom-right 4×4 block of CPU.

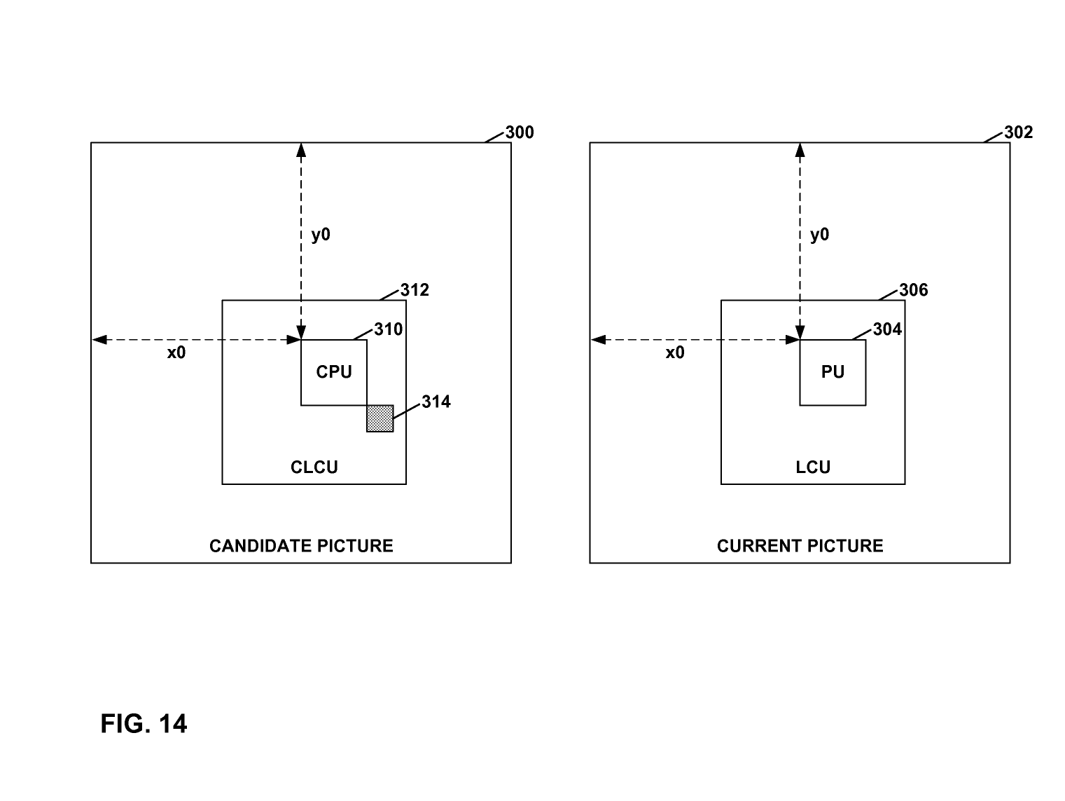

FIG. 14 is a conceptual diagram illustrating example candidate regions of a candidate picture 300. In the example of FIG. 14, a current picture 302 includes a region 304 associated with a current PU. Region 304 is within a region 306 associated with a current LCU. A top-left sample of region 304 is located at (x0, y0), relative to a top-left sample of current picture 302. In other words, the location of the top-left sample in the current PU in current picture 302 is denoted by (x0, y0). A CPU region 310 in candidate picture 300 has the same size as region 304. A top-left sample of CPU region 310 is located at (x0, y0), relative to a top-left sample of candidate picture 300. In other words, in candidate picture 300, the co-located region with the same size of PU and its top-left sample located at (x0, y0) is denoted by CPU. Region 312 of candidate picture has the same size as region 306 and is co-located with region 306. Region 314 of candidate picture 300 is located immediately below and immediately right of CPU region 310. In this way, the LCU that covers CPU is denoted by CLCU and the bottom-right block of CPU is denoted by BR.

Continuing reference is now made to the example of FIG. 13. To check the candidate regions of the current candidate picture, the video coder may, in response to determining that the video coder has not yet checked all candidate pictures (“NO” of 254), initialize a current candidate region indicator such that the current candidate region indicator indicates a first candidate region according to a candidate region checking order (256). The candidate region indicated by the candidate region indicator may be referred to herein as the current candidate region. If the current view is the view V1 (i.e., the view to the left of the base view), the candidate region checking order may be as follows: CPU region, CLCU region, and BR region. If the current view is the view V2 (i.e., the view to the right of the base view), the candidate region checking order may be as follows: BR region, CPU region, CLCU region. In other words, within each candidate picture, the corresponding three candidate regions in this picture will be checked in an order of (CPU, CLCU and BR) for V1 and (BR, CPU, CLCU) for V2.

After initializing the current candidate region indicator, the video coder may determine whether the video coder has checked all candidate regions of the current candidate picture (258). In response to determining that the video coder has not yet checked all candidate regions of the current candidate picture (“NO” of 258), the video coder may determine whether the current candidate region is associated with a disparity motion vector (260). When the current candidate region covers more than one 16×16 partition, the upper-left 4×4 block of each 16×16 partition in the current candidate region is scanned in raster scan order. When a PU that covers the upper-left 4×4 block of a 16×16 partition of the current candidate region has an available disparity motion vector, the video coder may determine that the disparity motion vector of the PU is the disparity motion vector associated with the current candidate region. Otherwise, when the current candidate region does not cover more than one 16×16 partition, the video coder may choose the upper-left 4×4 block of the current candidate region for the disparity vector derivation. That is, if the PU that covers the upper-left 4×4 block of the current candidate region has a disparity motion vector, the video coder may determine that this disparity motion vector is the disparity motion vector associated with the current candidate region.

In response to determining that the current candidate region is associated with a disparity motion vector (“YES” of 260), the video coder may determine, based on the disparity motion vector associated with the current candidate region, the disparity vector for the current PU (262). For instance, the video coder may determine that the disparity vector for the current PU is equal to a horizontal component of the RefPicList0 motion vector of the current spatially-neighboring PU. Otherwise, in response to determining that the current candidate region is not associated with a disparity motion vector (“NO” of 260), the video coder may set the current candidate region indicator to a next candidate region according to the candidate region checking order (264). The video coder may then determine again whether all candidate regions of the current candidate picture have been checked (258).

In response to determining that all candidate regions of the current candidate picture have been checked (“YES” of 258), the video coder may set a current candidate picture indicator to a next candidate picture according to a candidate picture checking order (266). The video coder may check the remaining candidate pictures (i.e., candidate pictures other than the co-located candidate picture) in an ascending order according to the reference indexes of the remaining candidate pictures. When one reference index corresponds to a picture in RefPicList0 and also corresponds to a picture in RefPicList1, the video coder may check the reference picture in RefPicListX prior to checking the reference picture in RefPicListY, where X is equal to collocated_from 10 flag and Y is equal to 1−X. After setting the current candidate picture indicator, the video coder may determine again whether the video coder has checked all of the candidate pictures (254).

In response to determining that the video coder has checked all of the candidate pictures (“YES” of 254), the video coder may use, as the disparity vector for the current PU, a zero disparity vector (268). A zero disparity vector may be a disparity vector with both horizontal and vertical parts set to 0.

In this way, the co-located reference picture from the current view is first checked. Then, each of the remaining candidate pictures is checked in ascending order of reference index. Within each candidate picture, the corresponding three candidate regions in this picture may be checked in an order of (CPU, CLCU and BR) for V1 and (BR, CPU, CLCU) for V2. Once a disparity motion vector is identified, the checking process may be terminated and the first available disparity motion vector may be returned as the disparity vector. If this process does not return an available disparity vector, a zero disparity vector (with both horizontal and vertical parts set to 0) may be returned as the disparity vector for inter-view motion prediction.

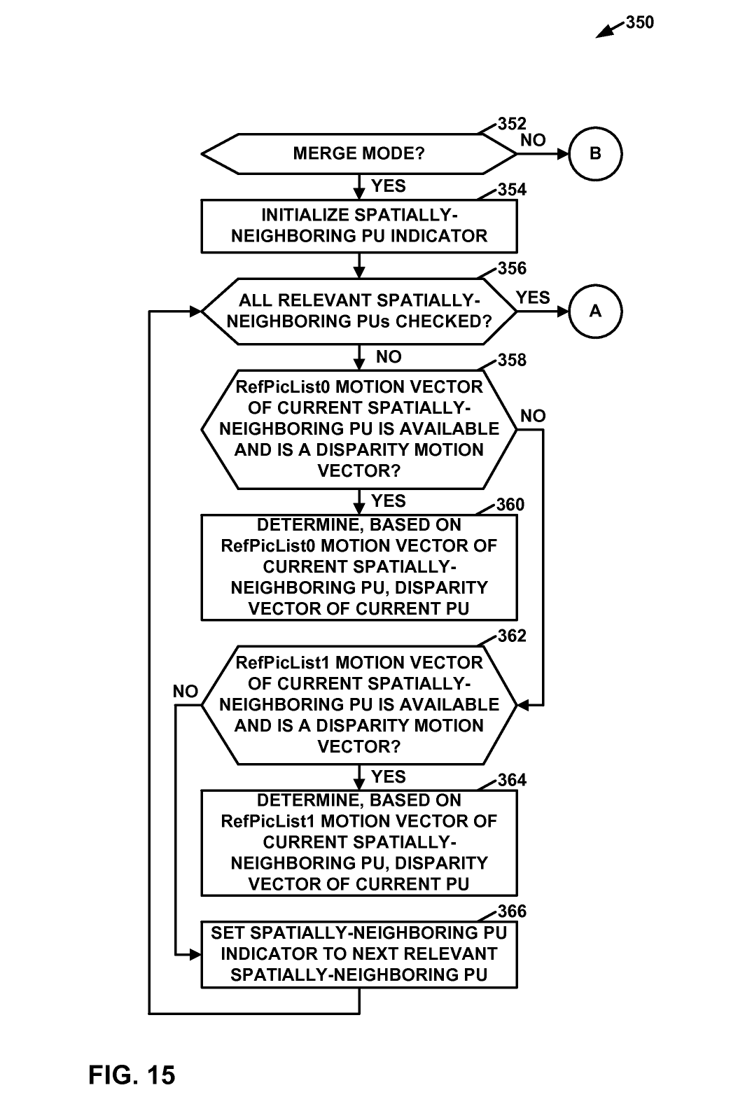

FIG. 15 is a flowchart illustrating an example disparity vector generation process 350. Disparity vector generation process 350 may be performed by a video encoder (e.g., video encoder 20), a video decoder (e.g., video decoder 30), or another device. Disparity vector generation process 350 may be performed to determine a disparity vector for a current PU for purposes of merge mode, AMVP mode, or inter-view residual prediction. The video coder may perform disparity vector generation process 350 for each of a view V1 and a view V2, where V1 is left of a base view and V2 is right of the base view.

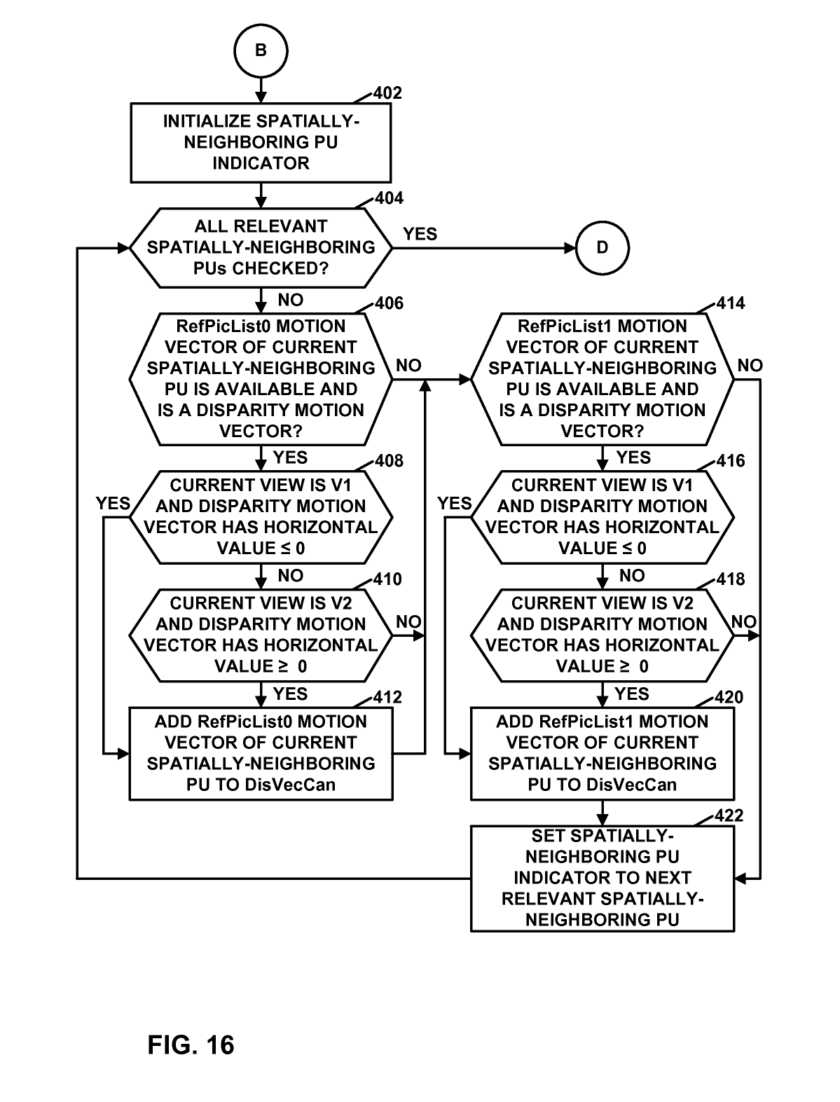

In the example of FIG. 15, the video coder may determine whether disparity vector generation process 350 is being performed to determine the motion information of a current PU using merge mode PU (352). In response to determining that disparity vector generation process 350 is not being performed to determine the motion information of the current PU using merge mode (“NO” of 352), the video coder may perform a portion of disparity vector generation process 350 shown in the example of FIG. 16 (denoted in FIG. 15 as “B”). For instance, the video coder may perform the portion of disparity vector generation process 350 shown in FIG. 16 when disparity vector generation process 350 is being performed to determine the motion information of the current PU using AMVP mode or when disparity vector generation process 350 is being performed as part of an inter-view residual prediction process for the current PU.

In response to determining that disparity vector generation process 350 is being performed to determine the motion information of the current PU using merge mode (“YES” of 352), the video coder may initialize a spatially-neighboring PU indicator such that the spatially-neighboring PU indicator indicates a first relevant spatially-neighboring PU according to a checking order (354). In some examples, the relevant spatially-neighboring PUs may be PUs that cover locations A₀, A₁, B₀, B₁, and B₂, as shown in the example of FIG. 2. In some examples, the video coder may check the relevant spatially-neighboring PUs according to the following order of locations: A₁, B₁, B₀, A₀, and B₂. Thus, the video coder may check the spatial neighboring prediction unit N (with N being replaced by A₁, B₁, B₀, A₀ and B₂ in order).

Next, the video coder may determine whether all relevant spatially-neighboring PUs have checked (356). In response to determining that the video coder has not yet checked all of the relevant spatially-neighboring PUs (“NO” of 356), the video coder may determine whether a RefPicList0 motion vector of the current spatially-neighboring PU is available and is a disparity motion vector (358). The current spatially-neighboring PU may be the PU indicated by the spatially-neighboring PU indicator. In response to determining that the RefPicList0 motion vector of the current spatially-neighboring PU is available and is a disparity motion vector (“YES” of 358), the video coder may determine, based on the RefPicList0 motion vector of the current spatially-neighboring PU, the disparity vector for the current PU (360). For instance, the video coder may determine that the disparity vector for the current PU is equal to a horizontal component of the RefPicList0 motion vector of the current spatially-neighboring PU.

On the other hand, in response to determining that the RefPicList0 motion vector of the current spatially-neighboring PU is not available or not a disparity motion vector (“NO” of 358), the video coder may determine whether a RefPicList1 motion vector of the current spatially-neighboring PU is available and is a disparity motion vector (362). In response to determining that the RefPicList1 motion vector of the current spatially-neighboring PU is available and is a disparity motion vector (“YES” of 362), the video coder may determine, based on the RefPicList1 motion vector of the current spatially-neighboring PU, the disparity vector for the current PU (364). For instance, the video coder may determine that the disparity vector for the current PU is equal to a horizontal component of the RefPicList0 motion vector of the current spatially-neighboring PU.

However, in response to determining that the RefPicList1 motion vector of the current spatially-neighboring PU is not available or is not a disparity motion vector (“NO” of 362), the video coder may set the spatially-neighboring PU indicator to the next relevant spatially-neighboring PU (366). The video coder may then determine again whether the video coder has checked all of the relevant spatially-neighboring PUs (356). In this way, for each of the neighboring PU N, if the motion vector from RefPicList0 is available and it is a disparity motion vector, it is returned as the final disparity vector. Otherwise, the motion vector from RefPicList1, if available, is checked. If the motion vector from RefPicList1 is a disparity motion vector, the motion vector from RefPicList1 is used as the disparity vector for inter-view motion prediction applied to the merge mode.

In response to determining that the video coder has checked all of the relevant spatially-neighboring PUs (“YES” of 356), the video coder may perform a derivation process for temporal disparity vectors indicated in the example of FIG. 15 as “A.” In some examples, when the video coder has checked all of the relevant spatially-neighboring PUs, the video coder may the example process shown in FIG. 13.

In this way, the derivation process for temporal disparity vectors is invoked when there are no disparity motion vectors identified in the above derivation process for spatial disparity vectors. The definition of temporal neighboring blocks and the checking order of them are the same as described with regard to the example of FIG. 13. If this process does not return an available disparity vector, a zero disparity vector (with both horizontal and vertical parts set to 0) may be returned as the disparity vector.

FIG. 16 is a flowchart illustrating an example disparity vector generation process for the AMVP and inter-view residual prediction modes. In other words, for the disparity vector generated for inter-view motion prediction applied to the AMVP mode and interview-residual prediction, the method of FIG. 16 may be utilized. In this way, a first disparity motion vector derivation process may be performed for merge mode and a second disparity motion vector derivation process may be performed for AMVP mode and inter-view residual prediction. Disparity vector generation process may be part of the disparity vector generation process 350 of FIG. 15. As described below, in the example of FIG. 16, spatial neighboring blocks are firstly checked, followed by temporal neighboring blocks.

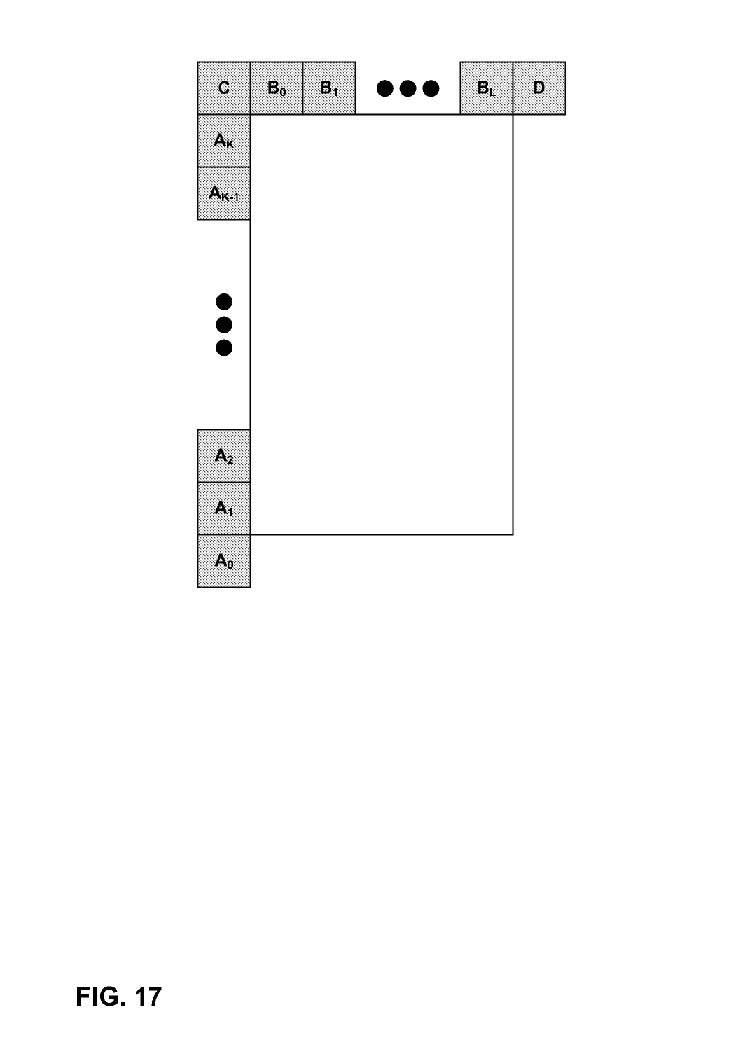

In the example of FIG. 16, the video coder may initialize a spatially-neighboring PU indicator such that the spatially-neighboring PU indicator indicates a first relevant spatially-neighboring PU according to a checking order (402). FIG. 17 is a conceptual diagram illustrating example locations that spatially neighbor a current PU. In the example of FIG. 16, the relevant spatially-neighboring PUs may be the PUs that cover locations A₀ to Aₖ, B0 to BL, C and D as shown in the example of FIG. 17.

After initializing the spatially-neighboring PU indicator, the video coder may then determine whether all of the relevant spatially-neighboring PUs have been checked (404). In response to determining that the video coder has not yet checked all of the relevant spatially-neighboring PUs (“NO” of 404), the video coder may determine whether the RefPicList0 motion vector of the current spatially-neighboring PU is available and is a disparity motion vector (406). In response to determining that the RefPicList0 motion vector of the current spatially-neighboring PU is available and is a disparity motion vector (“YES” of 406), the video coder may determine whether the current view is view V1 (i.e., a view to the left of a base view) and the disparity motion vector has a horizontal value that is less than or equal to 0 (408). In response to determining that the current view is not view V1 or that the disparity motion vector has a horizontal value that is not less than or equal to 0 (“NO” of 408), the video coder may determine whether the current view is view V2 (i.e., a view to the right of the base view) and the disparity motion vector has a horizontal value that is greater than or equal to 0 (410).

In response to determining that the current view is view V1 and the disparity motion vector has a horizontal value less than or equal to 0 (“YES” of 408) or in response to determining that the current view is view V2 and the disparity motion vector has a horizontal value greater than or equal to 0 (“YES” of 408), the video coder may add the RefPicList0 motion vector of the current spatially-neighboring PU to disVecCan (412). disVecCan may be initialized as an empty list.

After adding the RefPicList0 motion vector of the current spatially-neighboring PU to disVecCan, in response to determining that the current view is not view V2 or that the disparity motion vector does not have a horizontal value greater than or equal to 0 (“NO” of 410), or in response to determining that the RefPicList0 motion vector of the current spatially-neighboring PU is not available or is not a disparity motion vector (“NO” of 406), the video coder may determine whether the RefPicList1 motion vector of the current spatially-neighboring PU is available and is a disparity motion vector (414). In response to determining that the RefPicList 1 motion vector of the current spatially-neighboring PU is available and is a disparity motion vector (“YES” of 414), the video coder may determine whether the current view is view V1 (i.e., a view to the left of a base view) and the disparity motion vector has a horizontal value that is less than or equal to 0 (416). In response to determining that the current view is not view V1 or that the disparity motion vector has a horizontal value that is not less than or equal to 0 (“NO” of 416), the video coder may determine whether the current view is view V2 (i.e., a view to the right of the base view) and the disparity motion vector has a horizontal value that is greater than or equal to 0 (418).

In response to determining that the current view is view V1 and the disparity motion vector has a horizontal value less than or equal to 0 (“YES” of 416) or in response to determining that the current view is view V2 and the disparity motion vector has a horizontal value greater than or equal to 0 (“YES” of 418), the video coder may add the RefPicList1 motion vector of the current spatially-neighboring PU to disVecCan (420). After adding the RefPicList1 motion vector of the current spatially-neighboring PU to disVecCan, the video coder may set the spatially-neighboring PU indicator to indicate a next relevant spatially-neighboring PU according to the checking order for the relevant spatially-neighboring PUs (420). After setting the spatially-neighboring PU indicator, or in response to determining that the RefPicList 1 motion vector of the current spatially-neighboring PU is not available or is not a disparity motion vector (“NO” of 414), or in response to determining that the current view is not V2 or the disparity motion vector does not have a horizontal value that is greater than or equal to 0 (“NO” of 418), the video coder may set the spatially-neighboring PU indicator to the next relevant spatially-neighboring PU according to the checking order (422). The video coder may then determine again whether the video coder has checked all of the relevant spatially-neighboring PUs (404).

In this way, for each of the neighboring blocks, both forward and backward motion vectors (corresponding to RefPicList0 and RefPicList1, respectively), if available, are checked and added to disVecCan if it is a disparity motion vector and one of the following conditions is true:
If the current view is V1 and the disparity motion vector has a horizontal value smaller or equal to 0.
If the current view is V2 and the disparity motion vector has a horizontal value larger or equal to 0.

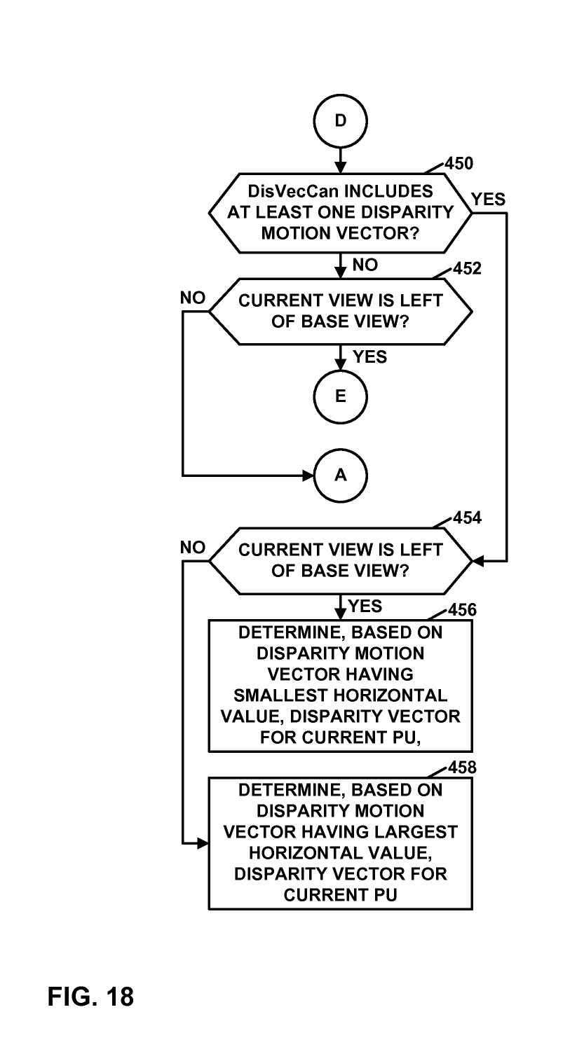

In response to determining that the video coder has checked all of the relevant spatially-neighboring PUs (“YES” of 404), the video coder may perform the portion of disparity vector generation process 350 shown in FIG. 18 (marked in FIG. 16 as “D”).

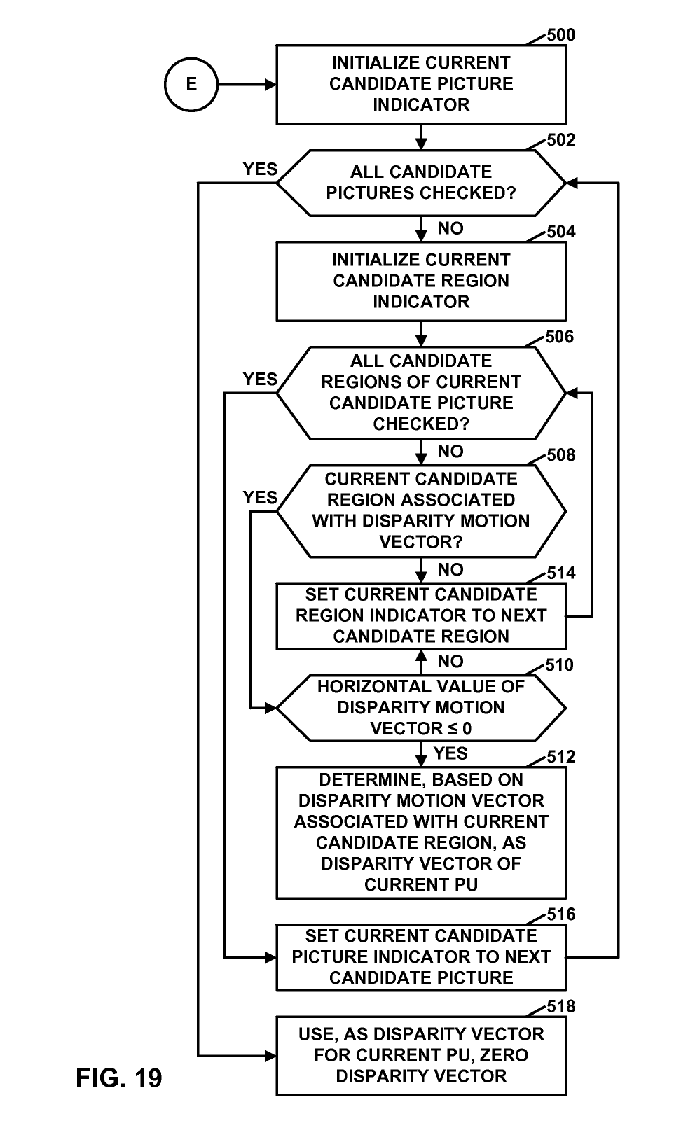

FIG. 18 is a flowchart illustrating an example continuation of disparity vector generation process 350 of FIGS. 15 and 16. In the example of FIG. 18, the video coder may determine whether disVecCan includes at least one disparity motion vector (450). If disVecCan does not contain at least one disparity motion vector, the video coder may invoke a derivation process for temporal disparity vectors. Specifically, in the example of FIG. 18, in response to determining that disVecCan does not include any disparity motion vectors (“NO” of 450), the video coder may determine whether the current view is left of the base view (452). In other words, the video coder may determine whether the current view is view V1. In response to determining that the current view is left of the base view (“YES” of 452), the video coder perform the portion of disparity vector generation process 350 shown in FIG. 19 (marked in FIG. 18 as “E”).

In response to determining that the current view is not to the left of the base view (i.e., the current view is view V2) (“NO” of 452), the video coder may perform a different derivation process for temporal disparity vectors (marked in the example of FIG. 18 as “A”). In some examples, when the current view is view V2, the video coder may perform the derivation process for temporal disparity vectors shown in FIG. 13. That is, if the current view is V2, the following process is invoked: following the same definition of temporal neighboring blocks and the checking order as described in FIG. 13, the first available disparity motion vector is returned as the final disparity vector. If no such a disparity motion vector is found, a zero disparity vector (with both horizontal and vertical parts set to 0) may be returned as the disparity vector.

Otherwise, if disVecCan includes at least one disparity vector, the video coder may invoke a process to select a most-preferred spatial disparity motion vector and return. That is, in response to determining that disVecCan includes at least one disparity motion vector (“YES” of 450), the video coder may determine whether the current view is left of the base view (454). In other words, the video coder may determine whether the current view is view V1. In response to determining that the current view is left of the base view (“YES” of 454), the video coder may determine, for purposes of AMVP mode and inter-view residual prediction, based on the disparity motion vector in disVecCan with the smallest horizontal value, the disparity vector for the current PU (456). In other words, if the current view is V1, return the disparity motion vector that has the smallest disparity value, among all entries in disVecCan.

Otherwise, in response to determining that the current view is not left of the base view (“NO” of 454), the video coder may determine, for purposes of AMVP mode and inter-view residual prediction, based on the disparity motion vector in disVecCan having the largest horizontal value, the disparity vector for the current PU (458). In other words, if the current view is view V2, return the disparity motion vector that has the largest horizontal disparity value, among all entries in disVecCan.

FIG. 19 is a flowchart illustrating an example continuation of the disparity vector generation process 350 of FIGS. 15, 16 and 17. As illustrated in the example of FIG. 19, the video coder may initialize a current candidate picture indicator such that the current candidate picture indicator indicates a co-located reference picture from the current view (500). If the current slice (i.e., the slice containing the current PU) is in a B slice and a collocated_from_{—}10_flag syntax element in a slice header of the current slice indicates that the co-located reference picture is in RefPicList1, the co-located reference picture may be the reference picture in RefPicList1 at a location indicated by a collocated_ref_idx syntax element of the slice header. Otherwise, if the current slice is a P slice or the current slice is a B slice and the collocated_from_{—}10_flag syntax element in the slice header of the current slice indicates that the co-located reference picture is in RefPicList0, the co-located reference picture may be the reference picture in RefPicList0 at a location indicated by the collocated_ref_idx syntax element of the slice header. The candidate picture indicated by the current candidate picture indicator may be referred to herein as the current candidate picture.

Furthermore, the video coder may determine whether all of the candidate pictures have been checked (502). When the video coder has not yet checked all of the candidate pictures, the video coder may check the current candidate picture. When the video coder checks the current candidate picture, the video coder may check the CPU region, the CLCU region, and the BR region of the current candidate picture. To check the candidate regions of the current candidate picture, the video coder may, in response to determining that the video coder has not yet checked all of the candidate pictures (“NO” of 502), initialize a current candidate region indicator such that the current candidate region indicator indicates a first candidate region according to a candidate region checking order (504). The candidate region indicated by the candidate region indicator may be referred to herein as the current candidate region. The candidate region checking order may be as follows: CPU region, CLCU region, and BR region.

After initializing the current candidate region indicator, the video coder may determine whether the video coder has checked all candidate regions of the current candidate picture (506). In response to determining that the video coder has not yet checked all candidate regions of the current candidate picture (“NO” of 506), the video coder may determine whether the current candidate region is associated with a disparity motion vector (508). When the current candidate region covers more than one 16×16 partition, the upper-left 4×4 block of each 16×16 partition in the current candidate region is scanned in raster scan order. When a PU that covers the upper-left 4×4 block of a 16×16 partition of the current candidate region has an available disparity motion vector, the video coder may determine that the disparity motion vector of the PU is the disparity motion vector associated with the current candidate region. Otherwise, when the current candidate region does not cover more than one 16×16 partition, the video coder may choose the upper-left 4×4 block of the current candidate region for the disparity vector derivation. That is, if the PU that covers the upper-left 4×4 block of the current candidate region has a disparity motion vector, the video coder may determine that this disparity motion vector is the disparity motion vector associated with the current candidate region.

In response to determining that the current candidate region is associated with a disparity motion vector (“YES” of 508), the video coder may determine whether a horizontal value of the disparity motion vector is less than or equal to 0 (510). In response to determining that the horizontal value of the disparity motion vector is less than or equal to 0 (“YES” of 510), the video coder may determine, for purposes of AMVP mode and inter-view residual prediction, based on the disparity motion vector associated with the current candidate region, the disparity vector for the current PU (512).

Otherwise, in response to determining that the horizontal value of the disparity motion vector is not less than or equal to 0 (“NO” of 510) or in response to determining that the current candidate region is not associated with a disparity motion vector (“NO” of 508), the video coder may set the current candidate region indicator to a next candidate region according to the candidate region checking order (514). The video coder may then determine again whether all candidate regions of the current candidate picture have been checked (506).

In response to determining that all candidate regions of the current candidate picture have been checked (“YES” of 506), the video coder may set a current candidate picture indicator to a next candidate picture according to a candidate picture checking order (516). The video coder may check the remaining candidate pictures in an ascending order according to the reference indexes of the remaining candidate pictures. When one reference index corresponds to a picture in RefPicList0 and also corresponds to a picture in RefPicList1, the video coder may check the reference picture in RefPicListX prior to checking the reference picture in RefPicListY, where X is equal to collocated_from_{—}10_flag and Y is equal to 1−X. After setting the current candidate picture indicator, the video coder may determine again whether the video coder has checked all of the candidate pictures (502).

In response to determining that the video coder has checked all of the candidate pictures (“YES” of 502), the video coder may use, as the disparity vector for the current PU, for purposes of AMVP mode and inter-view residual prediction, a zero disparity vector (518). The zero disparity vector may be a disparity vector with both horizontal and vertical parts set to 0.

In this way, if the current view is V1, the following process is invoked. Following the same definition of temporal neighboring blocks and the same checking order as described in FIG. 13, the first available disparity motion vector with the horizontal value smaller or equal to 0 is returned as the final disparity vector. If no such a disparity motion vector is found, a zero disparity vector (with both horizontal and vertical parts set to 0) may be returned as the disparity vector.

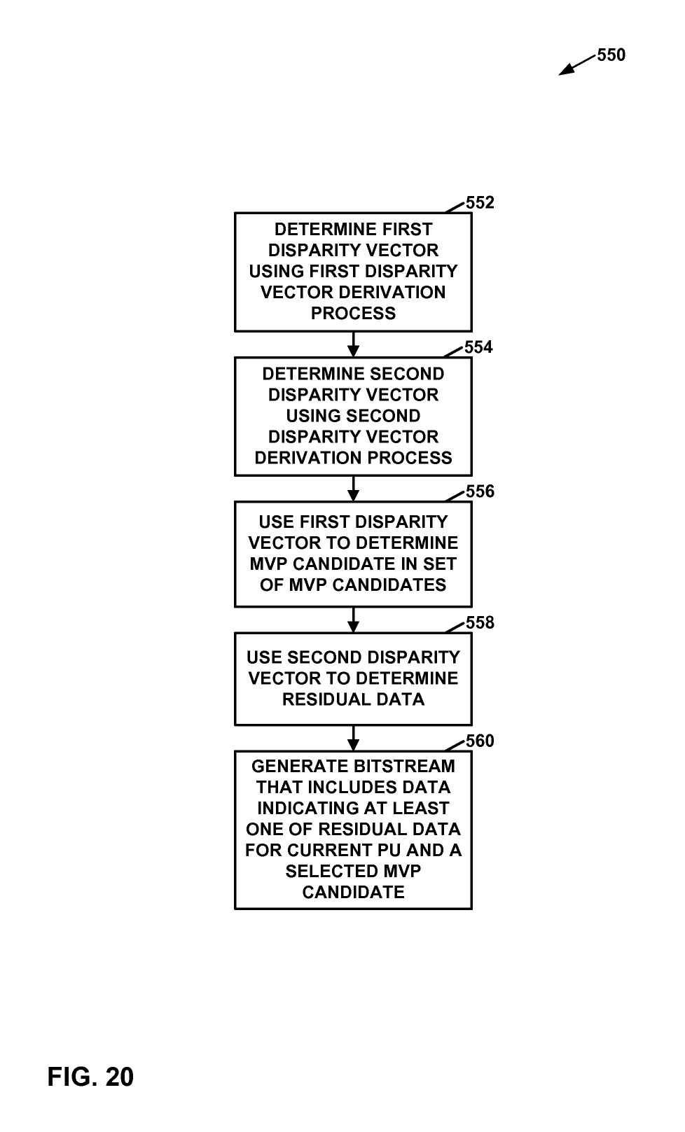

FIG. 20 is a flowchart illustrating an example operation 550 of video encoder 20, in accordance with one or more techniques of this disclosure. In the example of FIG. 20, video encoder 20 may determine a first disparity vector using a first disparity vector derivation process (552). Furthermore, video encoder 20 may determine a second disparity vector using a second disparity vector derivation process, wherein the first disparity vector derivation process is different than the second disparity vector derivation process (554). In addition, video encoder 20 may use the first disparity vector to determine a MVP candidate in a set of MVP candidates for a current PU (556). In addition, video encoder 20 may use the second disparity vector to determine residual data (558). Furthermore, video encoder 20 may generate a bitstream that includes data indicating the residual data for the current PU and a selected MVP candidate in the set of MVP candidates (560).

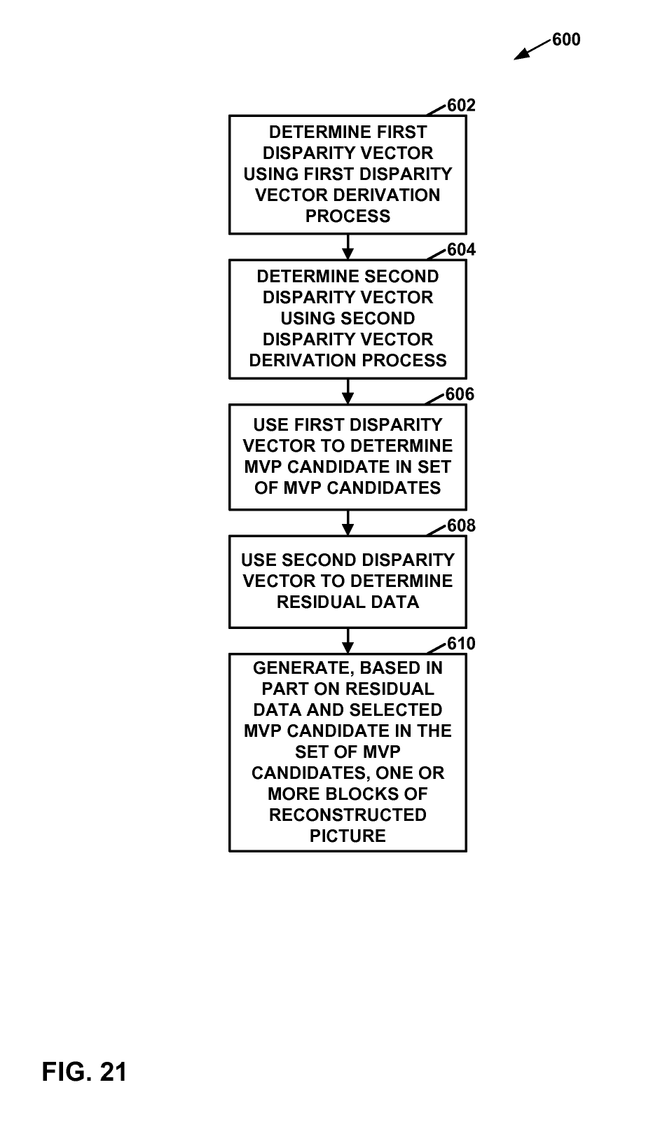

FIG. 21 is a flowchart illustrating an example operation 600 of video decoder 30, in accordance with one or more techniques of this disclosure. In the example of FIG. 21, video decoder 30 may determine a first disparity vector using a first disparity vector derivation process (602). In addition, video decoder 30 may determine a second disparity vector using a second disparity vector derivation process. The first disparity vector derivation process may be different than the second disparity vector derivation process (604). Furthermore, video decoder 30 may use the first disparity vector to determine a MVP candidate in a set of MVP candidates for a current prediction unit (PU) (606). Video decoder 30 may use the second disparity vector to determine residual data (608). In addition, video decoder 30 may generate, based in part on the residual data and a selected MVP candidate in the set of MVP candidates, one or more blocks of a reconstructed picture (610).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a first disparity vector using a first disparity vector derivation process;
determining a second disparity vector using a second disparity vector derivation process, wherein the first disparity vector derivation process is different than the second disparity vector derivation process;
using the first disparity vector to determine a motion vector prediction (MVP) candidate in a set of MVP candidates for a current prediction unit (PU);
using the second disparity vector to determine residual data; and
generating, based in part on the residual data and a selected MVP candidate in the set of MVP candidates, one or more blocks of a reconstructed picture.

2. The method of claim 1, wherein determining the first disparity vector comprises using different disparity vector derivation processes to determine the first disparity vector depending on whether motion information of the current PU is encoded using a first mode or a second mode.

3. The method of claim 2, further comprising:
obtaining, from a bitstream, a candidate index;
generating the set of MVP candidates;
determining, based at least in part on the candidate index, the selected MVP candidate in the set of MVP candidates, wherein the selected MVP candidate specifies a motion vector for the current PU when the motion information of the current PU is encoded using the first mode; and
when the motion information of the current PU is encoded using the second mode:
obtaining, from the bitstream, a motion vector difference (MVD) for the current PU; and
determining, based at least in part on a motion vector indicated by the selected MVP candidate and the MVD, the motion vector of the current PU.

4. The method of claim 1, further comprising:
determining, based at least in part on the selected MVP candidate, a predictive block for the current PU; and
generating, based at least in part on the predictive block for the current PU and the residual data, a reconstructed block.

5. A method of encoding video data, the method comprising:
determining a first disparity vector using a first disparity vector derivation process;
determining a second disparity vector using a second disparity vector derivation process, wherein the first disparity vector derivation process is different than the second disparity vector derivation process;
using the first disparity vector to determine a motion vector prediction (MVP) candidate in a set of MVP candidates for a current prediction unit (PU);
using the second disparity vector to determine residual data; and
generating a bitstream that includes data indicating the residual data for the current PU and a selected MVP candidate in the set of MVP candidates.

6. The method of claim 5, wherein determining the first disparity vector comprises using different disparity vector derivation processes to determine the first disparity vector depending on whether motion information of the current PU is encoded using a first mode or a second mode.

7. The method of claim 6, further comprising:
generating the set of MVP candidates;
generating a bitstream that includes a candidate index that indicates the selected MVP candidate in the set of MVP candidates, wherein the selected MVP candidate specifies a motion vector for the current PU when the motion information of the current PU is encoded using the first mode; and
when the motion information of the current PU is encoded using the second mode, including, in the bitstream, data indicating a motion vector difference (MVD) for the current PU, the MVD for the current PU indicating a difference between a motion vector indicated by the selected MVP candidate and a motion vector of the current PU.

8. A video coder comprising one or more processors configured to:
determine a first disparity vector using a first disparity vector derivation process;
determine a second disparity vector using a second disparity vector derivation process, wherein the first disparity vector derivation process is different than the second disparity vector derivation process;
use the first disparity vector to determine a motion vector prediction (MVP) candidate in a set of MVP candidates for a current prediction unit (PU); and
use the second disparity vector to determine residual data.

9. The video coder of claim 8, wherein the one or more processors are configured to use different disparity vector derivation processes to determine the first disparity vector depending on whether motion information of the current PU is encoded using a first mode or a second mode.

10. The video coder of claim 9, wherein the one or more processors are configured to:
obtain, from a bitstream, a candidate index;
generate the set of MVP candidates;
determine, based at least in part on the candidate index, a selected MVP candidate in the set of MVP candidates, wherein the selected MVP candidate specifies a motion vector for the current PU when the motion information of the current PU is encoded using the first mode; and
when the motion information of the current PU is encoded using the second mode:
obtain, from the bitstream, a motion vector difference (MVD) for the current PU; and
determine, based at least in part on a motion vector indicated by the selected MVP candidate and the MVD, the motion vector of the current PU.

11. The video coder of claim 9, wherein the one or more processors are configured to:
generate the set of MVP candidates;
generate a bitstream that includes a candidate index that indicates the selected MVP candidate in the set of MVP candidates, wherein the selected MVP candidate specifies a motion vector for the current PU when the motion information of the current PU is encoded using the first mode; and
when the motion information of the current PU is encoded using the second mode, including, in the bitstream, data indicating a MVD for the current PU, the MVD for the current PU indicating a difference between a motion vector indicated by the selected MVP candidate and a motion vector of the current PU.

12. The video coder of claim 8, wherein the one or more processors are configured to:
determine, based at least in part on the selected MVP candidate, a predictive block for the current PU; and
generate, based at least in part on the predictive block for the current PU and the residual data, a reconstructed block.

13. The video coder of claim 8, wherein the one or more processors encode video data.

14. The video coder of claim 8, wherein the one or more processors decode video data.

15. A video coder comprising:
means for determining a first disparity vector using a first disparity vector derivation process;
means for determining a second disparity vector using a second disparity vector derivation process, wherein the first disparity vector derivation process is different than the second disparity vector derivation process;
means for using the first disparity vector to determine a motion vector prediction (MVP) candidate in a set of MVP candidates for a current prediction unit (PU); and
means for using the second disparity vector to determine residual data.

16. The video coder of claim 15, further comprising means for using different disparity vector derivation processes to determine the first disparity vector depending on whether motion information of the current PU is encoded using a first mode or a second mode.

17. The video coder of claim 16, further comprising:
means for obtaining, from a bitstream, a candidate index;
means for generating the set of MVP candidates;
means for determining, based at least in part on the candidate index, a selected MVP candidate in the set of MVP candidates, wherein the selected MVP candidate specifies a motion vector for the current PU when the motion information of the current PU is encoded using the first mode;
means for obtaining, from the bitstream, when the motion information of the current PU is encoded using the second mode, a motion vector difference (MVD) for the current PU; and
means for determining, based at least in part on a motion vector indicated by the selected MVP candidate and the MVD, when the motion information of the current PU is encoded using the second mode, the motion vector of the current PU.

18. The video coder of claim 16, further comprising:
means for generating the set of MVP candidates;
means for generating a bitstream that includes a candidate index that indicates the selected MVP candidate in the set of MVP candidates, wherein the selected MVP candidate specifies a motion vector for the current PU when the motion information of the current PU is encoded using the first mode; and
means for including, in the bitstream, when the motion information of the current PU is encoded using the second mode, data indicating a MVD for the current PU, the MVD for the current PU indicating a difference between a motion vector indicated by the selected MVP candidate and a motion vector of the current PU.

19. A computer-readable storage medium having instructions stored thereon that, when executed, configure a video coder to:
determine a first disparity vector using a first disparity vector derivation process;
determine a second disparity vector using a second disparity vector derivation process, wherein the first disparity vector derivation process is different than the second disparity vector derivation process;
use the first disparity vector to determine a motion vector prediction (MVP) candidate in a set of MVP candidates for a current prediction unit (PU); and
use the second disparity vector to determine residual data.

20. The computer-readable storage medium of claim 19, wherein the instructions further configure to video coder to use different disparity vector derivation processes to determine the first disparity vector depending on whether motion information of the current PU is encoded using a first mode or a second mode.

21. The computer-readable storage medium of claim 20, wherein the instructions further configure the video coder to:
obtain, from a bitstream, a candidate index;
generate the set of MVP candidates;
determine, based at least in part on the candidate index, a selected MVP candidate in the set of MVP candidates, wherein the selected MVP candidate specifies a motion vector for the current PU when the motion information of the current PU is encoded using the first mode;
obtain, from the bitstream, when the motion information of the current PU is encoded using the second mode, a motion vector difference (MVD) for the current PU; and
determine, based at least in part on a motion vector indicated by the selected MVP candidate and the MVD, when the motion information of the current PU is encoded using the second mode, the motion vector of the current PU.

22. The computer-readable storage medium of claim 20, wherein the instructions further configure to video coder to:
generate the set of MVP candidates;
generate a bitstream that includes a candidate index that indicates a selected MVP candidate in the set of MVP candidates, wherein the selected MVP candidate specifies a motion vector for the current PU when the motion information of the current PU is encoded using the first mode; and
include, in the bitstream, when the motion information of the current PU is encoded using the second mode, data indicating a MVD for the current PU, the MVD for the current PU indicating a difference between a motion vector indicated by the selected MVP candidate and a motion vector of the current PU.
